(19) United States
(12) Patent Application Publication
(10) Pub. No.: US 2016/0312944 A1
(43) Pub. Date: Oct. 27, 2016

(54) SAFETY APPARATUS

(71) Applicant: Johnny McCoy, Garland, TX (US)

(72) Inventor: Johnny McCoy, Garland, TX (US)

(21) Appl. No.: 14/995,553

(22) Filed: Jan. 14, 2016

Related U.S. Application Data
(60) Provisional application No. 62/166,800, filed on May 27, 2015.
(60) Provisional application No. 62/100,736, filed on Jan. 7, 2015.

(51) Int. Cl. F16M 11/38; G09F 15/00

(52) U.S. Cl. CPC F16M 11/38; G09F 15/0068

(57) ABSTRACT

Disclosed is a device that includes at least one base with at least one top side and at least one bottom side, with the at least one top side having at least one opening. The device further includes at least one base leg corresponding to at least one opening of the base, which has at least one bottom portion configured to be inserted into at least one opening of the base. The device also includes at least one extending member attached to at least one base leg. The extending member or extending members project upwards when the device is in an extending position. The device includes at least one cross-connecting member oriented in a lateral direction and attached to at least one base leg and/or at least one extending member. Finally, the device includes at least one sign configured to attach to at least one cross-connecting member.

### CROSS-REFERENCED TO RELATED APPLICATIONS

This application claims the benefit of U.S. Provisional Application Nos. 62/100,736 filed Jan. 7, 2015 and 62/166,800 filed May 27, 2015. All of the foregoing are incorporated by reference in their entireties.

### BRIEF DESCRIPTION OF THE DRAWINGS

FIG. 1 illustrates a front view of an embodiment of the device.

FIG. 2 illustrates a perspective view of an embodiment of the device.

FIG. 3 illustrates a side view of an embodiment of the device.

FIG. 4 illustrates a plan view of an embodiment of the device.

FIG. 5 illustrates an exploded view of an embodiment of the device.

FIG. 6 illustrates a view of an embodiment of the base assembly of the device.

FIG. 7 illustrates a view of an embodiment of the base assembly, showing also the base legs and a cross-connecting member of an embodiment of the device.

FIG. 8 illustrates a view of an embodiment of the sign assembly of the device.

FIG. 9 illustrates an embodiment of the sign of the device.

FIG. 10 illustrates another embodiment of the sign of the device.

FIG. 11 illustrates a view of another embodiment of the sign assembly of the device.

FIG. 12 illustrates a view of an embodiment of the device in the collapsed position.

FIG. 13 illustrates a front view of another embodiment of the device.

FIG. 14 illustrates a perspective view of another embodiment of the device.

FIG. 15 illustrates an exploded view of another embodiment of the device.

FIG. 16 illustrates a view of another embodiment of the sign assembly of the device.

FIG. 17 illustrates a front view of another embodiment of the device.

FIG. 18 illustrates a perspective view of another embodiment of the device.

FIG. 19 illustrates an exploded view of another embodiment of the device.

FIG. 20 illustrates a view of another embodiment of the sign assembly of the device.

FIG. 21 illustrates a perspective view of an embodiment of the device.

FIG. 22 illustrates a side view of an embodiment of the device.

FIG. 23 illustrates a perspective view of an embodiment of the device, with the sign removed.

FIG. 24 illustrates another embodiment of the sign assembly of the device.

FIG. 25 illustrates an embodiment of the bottom portion of a base leg of the device.

FIG. 26 illustrates an embodiment of the base member in an embodiment of the device.

FIG. 27 illustrates a perspective view of an embodiment of the device.

FIG. 28 illustrates a view of an embodiment of the device in the collapsed position.

FIG. 29 illustrates a perspective view of an embodiment of the device.

FIG. 30 illustrates a front view of an embodiment of the device.

FIG. 31 illustrates a perspective view of an embodiment of the device.

FIG. 32 illustrates an embodiment of the base assembly of the device.

FIG. 33 illustrates an embodiment of the base assembly connection.

FIG. 34 illustrates a perspective view of an embodiment of the device.

FIG. 35 illustrates another embodiment of the base assembly of the device.

FIG. 36 illustrates another embodiment of the base assembly of the device.

FIG. 37 illustrates an embodiment of the base leg and base assembly connection of the device, before the leg is inserted.

FIG. 38 illustrates a cutaway view of an embodiment of the base leg and base assembly connection of the device, after the leg is inserted.

FIG. 39 illustrates a cutaway view of an embodiment of the base leg and base assembly connection of the device, after the leg is inserted with the locking member disengaged.

FIG. 40 illustrates an exploded view of an embodiment of the joint connection of the device.

FIG. 41 illustrates an embodiment of the sign connection of the device.

FIG. 42 illustrates an exploded view of an embodiment of the sign connection of the device to a cross-connecting member.

### DETAILED DESCRIPTION OF EMBODIMENTS

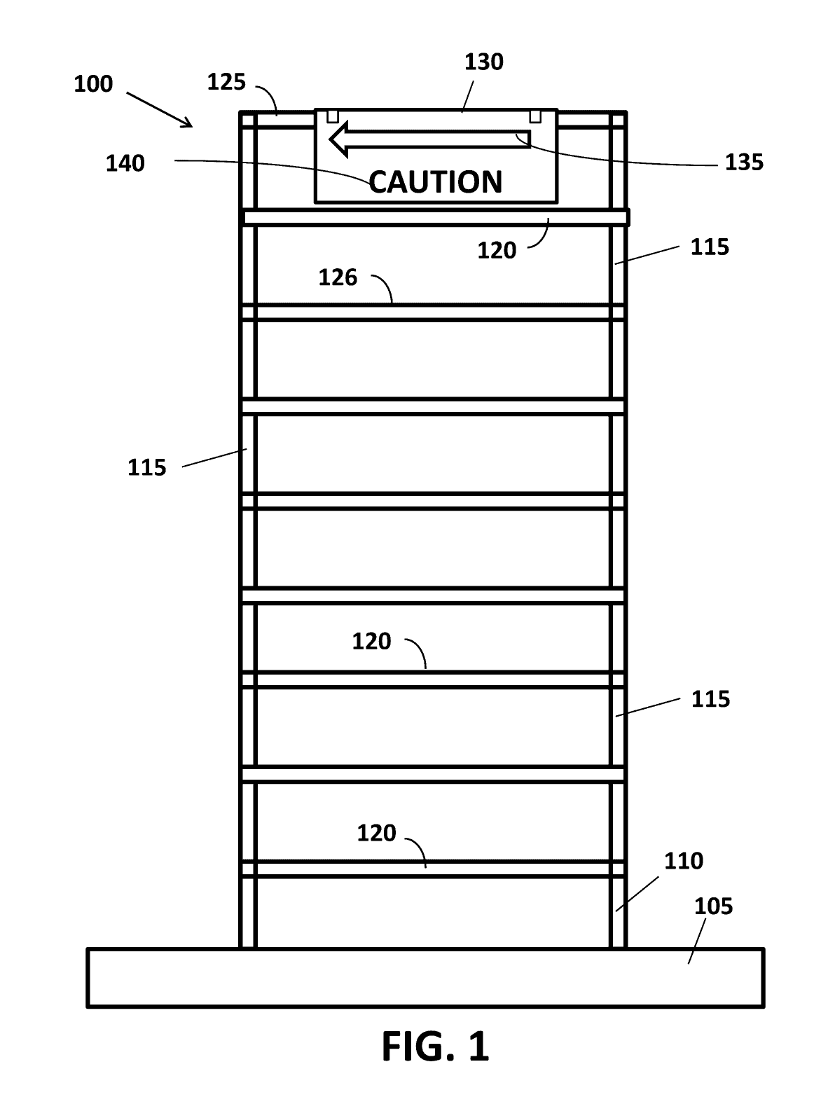

The present application relates to a device that may support a visible sign. FIG. 1 is a view of an embodiment of the device and shows the device 100 in the extended position. The device 100 may include a base assembly 105 connected to base legs 110. The base legs 110 may attach to extending members 115, which extend upwards in the extending position. The extending members 115 may project in this manner at an angle. The device 100 may also include cross-connecting members 120, which may increase stability. The cross-connecting members 120 may extend horizontally and may connect to the base legs 110 and the extending members 115.

The highest cross-connecting member 125 may be vertically highest from the ground when the base legs 110 and the extending members 115 are in the extending position. A sign 130 may be attached to the highest cross-connecting member 125. The manner that the sign 130 may be attached is described in more detail below, regarding FIG. 8.

The sign 130 may contain a symbol 135 and/or lettering 140. The symbol 135 may provide information such as an arrow pointing in a direction, an exclamation point, etc. The lettering 140 may provide a caution to, for example, an automobile driver and contain the word “CAUTION.” The lettering 140 may be of another similar warning such as “Danger”, “Warning”, “Alert”, etc. The lettering 140 is not limited to cautionary wording, and may contain instructions. Examples of lettering for instructions include “Parking”, “Exit”, “Turn here”, “Closed”, etc. The symbol 135 and/or lettering 140 may also convey other information, such as “Garage Sale”, “Discount Sale”, etc. for advertising purposes.

As shown in the embodiment of FIG. 1, the sign 130 may hang down in the upper rectangular prisms 230. The sign 130 remains visible between the extending members 115 and cross-connecting members 120.

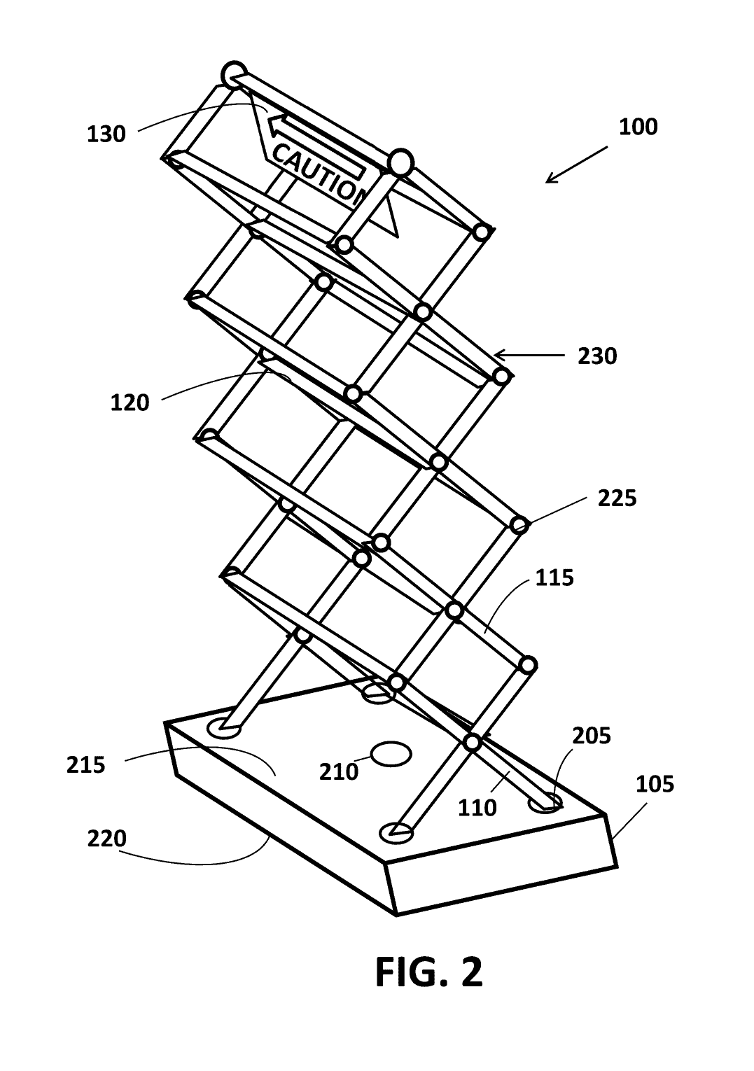

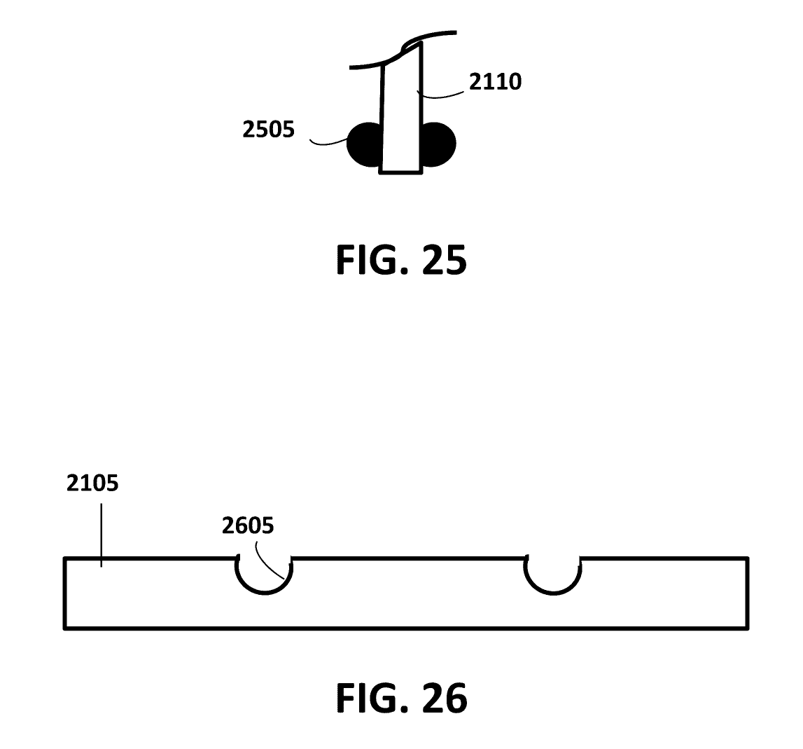

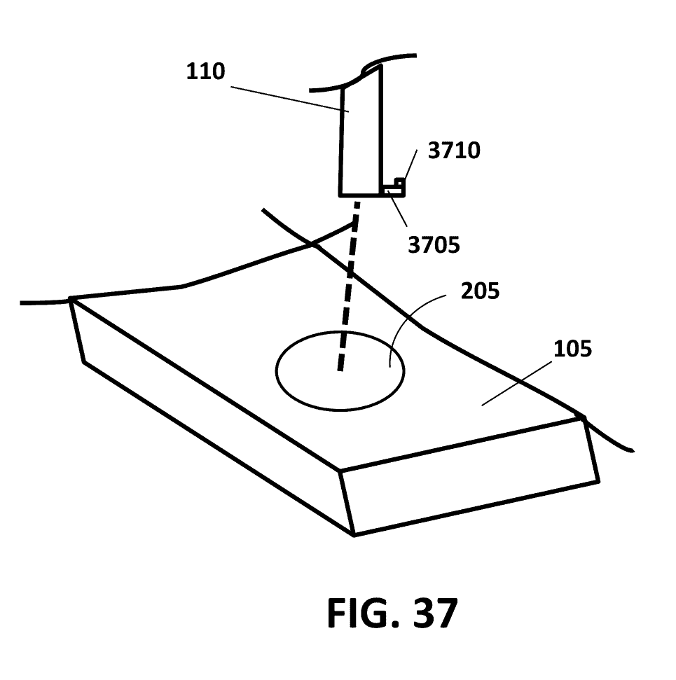

FIG. 2 is a perspective view of the embodiment discussed above. The base assembly 105 may include openings 205 for the base legs 110 to connect with. The base legs 110 may be configured to insert into the openings 205, which may allow the base legs 110 and extending members 115 to extend vertically upwards into the extending position. The base assembly 105 and base leg 110 connection is shown in more detail on FIGS. 37-39. One of ordinary skill will also recognize that the base assembly details shown in FIGS. 25-26 and discussed in more detail below can also be employed for the base leg 110 connection with the holes 205 of the base assembly 105.

FIG. 37 is a view of a portion of a base leg 110 and a portion of the base 105 to show one opening 205. As shown in the base embodiment of FIG. 37, the base legs 110 may contain at least one latching member 3705, which may be formed of a plastic, metal, spring material, or any other type of material. The latching member 3705 may extend outwards from the base leg 110 so that the width of the base leg 110 and latching member 3705 remains smaller than the diameter of the hole 205. This may allow the base leg 110 to be inserted into the hole 205. The latching member 3705 may be configured with a locking portion 3710 at an end and extending upwards of the latching portion to facilitate locking and unlocking of the base leg 110.

The base legs 110 may be held inside of the hole, for example, to maintain the extending position, by a securing element 3805. The securing element 3805 may be fit within or formed with the base assembly 105. The securing element 3805 may be sealed so that internal contents of the base assembly 105, such as water or sand, may not escape. A locking element 3810 may be provided on the securing element 3805 in an arrangement to mate with the locking portion 3710 of the latching member 3705 of the base leg 110.

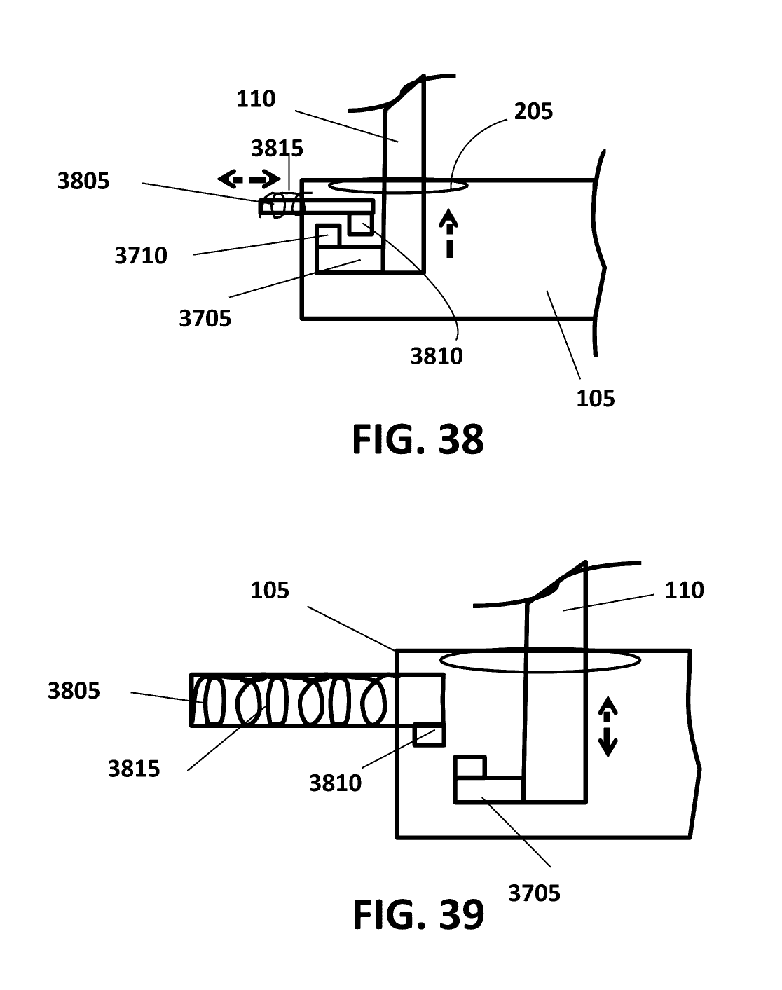

FIG. 38 shows an example embodiment illustration of a locked position and FIG. 39 shows an example embodiment illustration of the unlocked position. The securing element 3805 may be configured to move inwardly and outwardly by a user pushing the element. A spring 3815 may also be provided on the securing element 3805, to push the securing element 3805 into the unlocking position. As illustrated in the embodiment of FIGS. 39, if the spring is not compressed, the securing element 3805 and the locking element 3810 are in a position not to impede the vertical movement of the base leg 110. FIG. 38 demonstrates one example of how a user may insert the base leg 110, and then depress the securing member 3805 so that the spring 3815 compresses and the locking element 3810 extends over the latching member 3705 of the base leg 110.

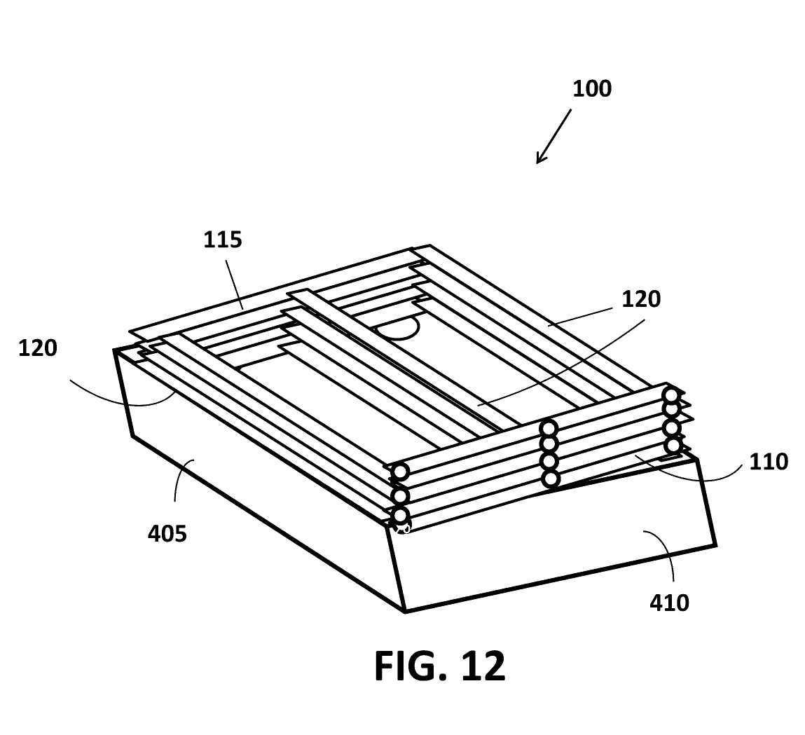

Turning back to FIG. 2, if the base legs 110 are removed from the openings 205, the base legs 110, extending members 115, and cross-connecting members 120 may be moved vertically downwards into the collapsed position. In the collapsed position, the base legs 110, extending members 115, and cross-connecting members 120 may be arranged parallel or nearly parallel to the base assembly 105. The collapsed position is shown in more detail in FIG. 12 and is discussed further below regarding that figure.

It should be noted that the base legs 110, extending members 115, and cross-connecting members 120 may have a variety of cross-section shapes. The figures illustrate that these components have a rectangular or square cross-section shape, but the components are not limited in this regard. For example, the various components of this device may have a circular, ovular, triangular, etc. cross-sectional shape.

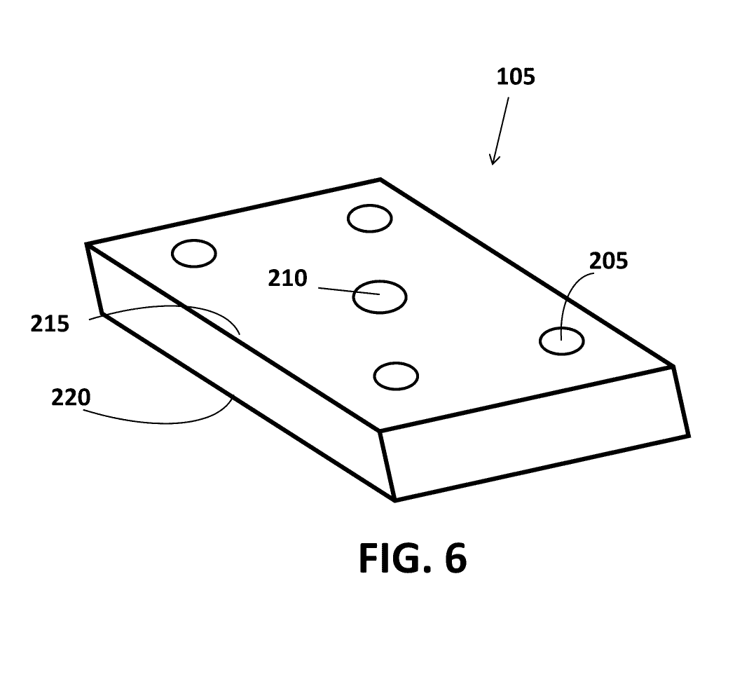

A filling opening 210 may be provided in the base assembly 105 as shown in FIG. 2. The filling opening 210 is discussed in more detail below regarding FIG. 6.

The base assembly 105 may include a top side 215 and a bottom side 220. As shown in the embodiment in FIG. 2, the filling opening 210 may be on the top side 215. A filling opening 210 could also be provided on the bottom side 220 in addition to, or instead of, locating the filling opening 210 on the top side 215. Also, although depicted as a circle in the center of the base assembly 215 in FIG. 2, the filling opening is not restricted to this location or this shape. It can be positioned anywhere on the base assembly 105 and can be in any other shape or configuration.

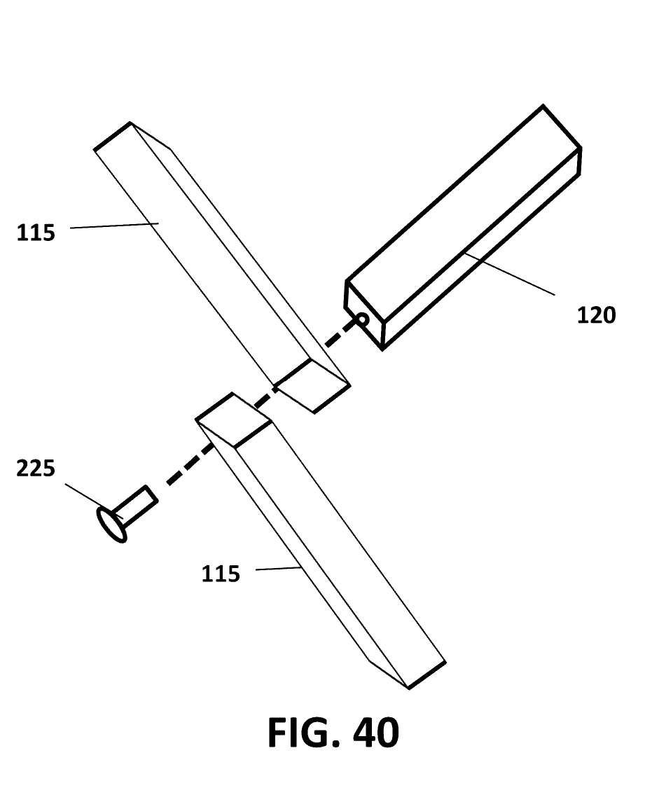

FIG. 2 also illustrates that joints 225 may be utilized where the base legs 110, connecting members 120, extending members 115, and any combination thereof connect on the sides of the device 100. In the embodiment shown, there are joints 225 at the bottom, midpoint, and top of the extending members 115. The joints 225 can be made of any standard fastener, such as a screw, bolt, bolt and washer, nail, pin, or any combination thereof, to connect the adjoining members of the device 100. FIG. 40 illustrates a closer up version to illustrate one connection example for the joints 225. As shown in the embodiment of FIG. 40, the joint 225 may be a screw that threads through at least one extending member 115 and into the cross-connecting member 120. The joint 225 may also be used to secure the base legs 110 connections in this manner. The joints 225 could also secure the base legs 110, extending members 115, and cross-connecting members 120 through other known fastening means instead of or in combination with the screw, such as bolts, bolts and washers, nails, pins, or any combination thereof.

In one embodiment, the extending members 115 and cross-connecting members 120 may be in the extending position and may form stacked rectangular prisms 230. FIG. 2 depicts four rectangular prisms 230, but other embodiments of the device could have more than four or less than four rectangular prisms 230.

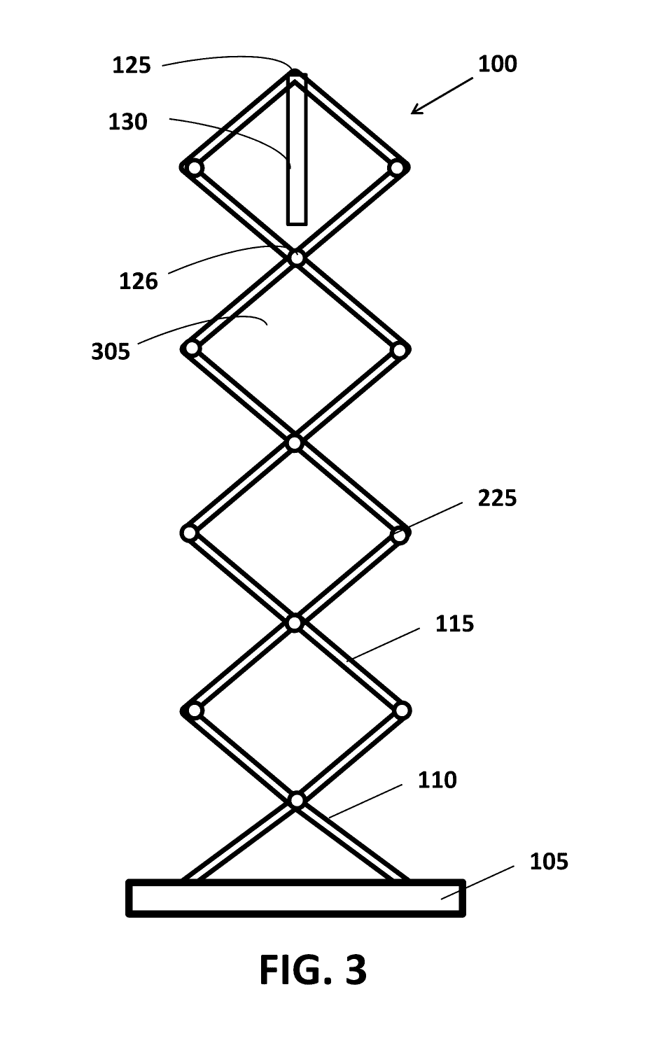

FIG. 3 presents a side view of the device 100 in the extending position. The sign 130 hangs down from the highest cross-connecting member 125. The sign 130 is shown as extending about three-fourths of the way to the next highest cross-connecting member 126 in this embodiment, but the sign could extend further down or less far down depending on the size of the sign 130 and the extending members 115. For example, as shown in FIG. 1, the sign 130 may extend only about halfway to the next highest cross-connecting member 126.

The base legs 110 and the extending members 115, while in the extending position, may form diamond-shapes 305 when viewed from the side view of the device 100 as shown in FIG. 3. FIG. 3 also shows the joints 225 may be sized at about the diameter or cross-sectional area of the cross-connecting members 120.

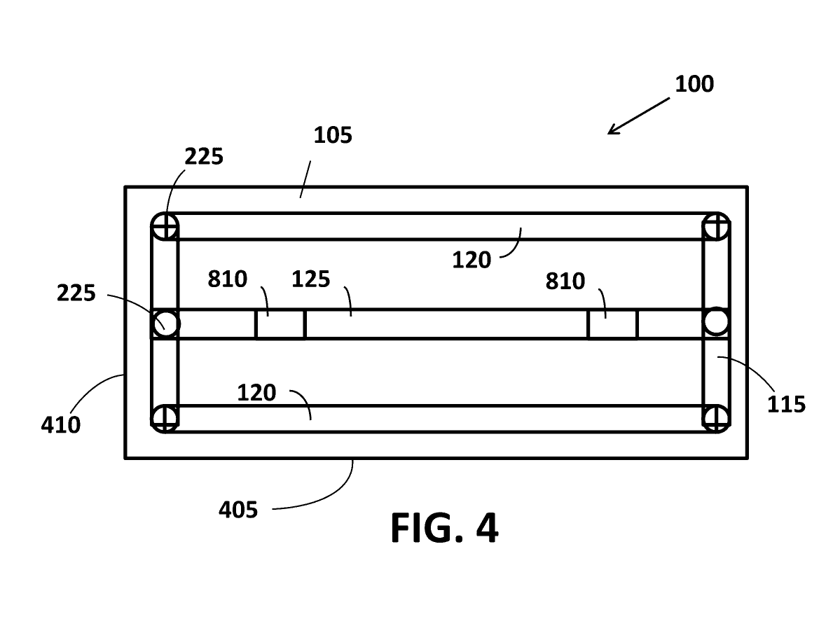

FIG. 4 is a top view of the device 100. The highest cross-connecting member 125 is shown between two of the other cross-connecting members 120. The sign 130 hangs from the highest cross-connecting member 125, but may not be seen from the view directly above the device. The highest cross-connecting member 125 also obscures the view of the next highest cross-connecting member 126 and the other cross-connecting members 120 that may be vertically lower than the highest cross-connecting member 120. The sign connectors 810 are shown on the top side of the highest cross-connecting member 120 and are discussed in more detail below regarding FIG. 8.

In some embodiments, the cross-connecting members 120 may be oriented in a direction parallel or substantially parallel with the longitudinal edge 405 of the base assembly 105. In some embodiments, the transverse edge 410 of the base assembly 105 may be parallel or substantially parallel to the extending members 115, as shown in the plan view of FIG. 4.

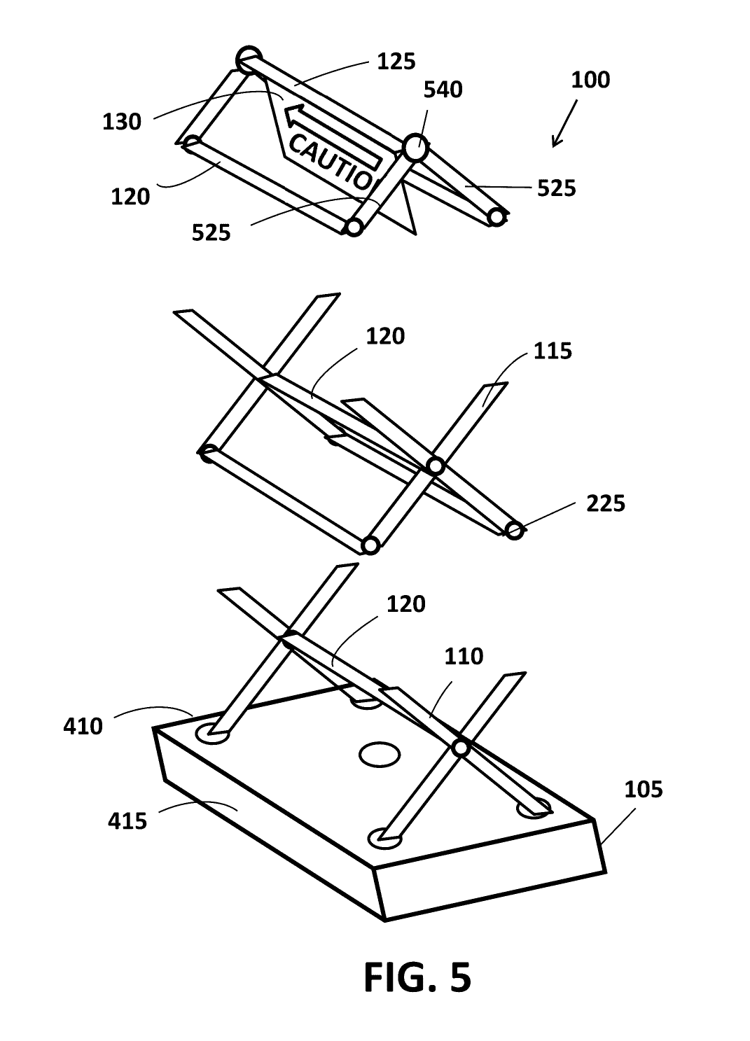

FIG. 5 illustrates an exploded perspective view of the device 100. For clarity, only one of the central extending members 115 and cross-connecting members 120 is shown, but the device is not limited to only one central section. Sections with this configuration may be added or omitted to increase or decrease the overall height of the device.

A top portion of one of the base legs 110 may connect to a bottom portion of an extending member. One of the joints 225 may secure this connection in the manner discussed above and depicted in FIG. 40. Cross-connecting members 120 may be oriented to be parallel or substantially parallel with the longitudinal edge 405 of the rectangular base 105 and may connect two opposite joints 225 that are at the same height. The cross-connecting members 120 may be utilized to connect the respective bottom portions, midpoints, and upper portions of extending members 115 that are opposite to one another. Again, each of these connection points is secured with a joint 225.

The highest extending members 525 may be shorter in length than the other extending members 115. There may be joints 225 only at the bottom portion and top portion of the highest extending members 525. The top portion of the highest extending members 525 may be connected to the highest cross-connecting member 125. This structure may provide support for the sign 130. The highest joint 540 may be larger than the other joints 225 if necessary, for example, to support the weight of the sign 130. In another embodiment, the highest joint 540 may be sized substantially the same as the other joints 225. The highest extending members 525 may also be the same or greater in length than the other extending members 115.

FIG. 6 shows only the base assembly 105 of the device 100. The filling opening 210 may be removable. Removal of the filling opening 210 may allow the base assembly to be filled with a liquid or non-liquid material (not shown), such as water or sand. In one embodiment, filling the base assembly 105 with the liquid or non-liquid material may increase the weight of the base assembly to possibly provide greater stability for the device 100.

In another embodiment, the base assembly 105 may be constructed out of a metallic or polymeric material such as steel, lead, iron, hard plastic, rubber, or any combination thereof. Constructing the base assembly out of a heavier material may increase stability. For these materials, the base assembly 105 may be heavy enough that filling the base assembly 105 through the filling opening 210 is unnecessary, and in some embodiments, the filling opening 210 does not have to be provided.

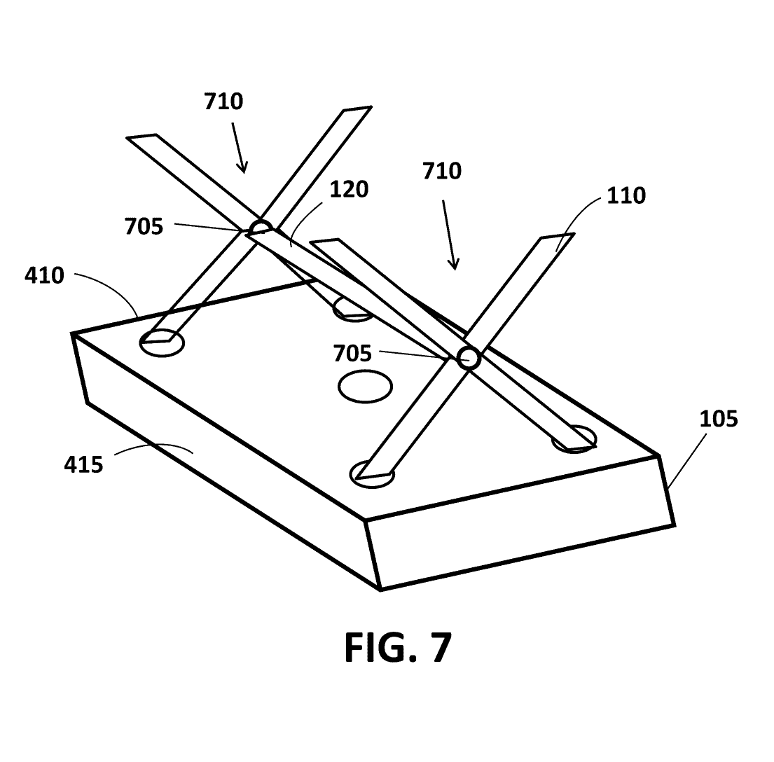

The position and connection of the base legs 110 into the base assembly 105 and the base leg 110 and cross-connecting member 120 connection, while the device is in the extended position in one embodiment, is more clearly shown on FIG. 7. Two of the base legs 110 extend upwards at an angle and cross at a midpoint 705 of the base legs. In this manner, the two base legs 110 may form an X-shape 710.

Near the opposite transverse edge 410 of the base assembly 105, two more base legs 110 may extend upwards, cross and connect at another midpoint 705, to form another X-shape 710. A cross-connecting member 120 may connect the two X-shapes 710 at the midpoints 705. This cross-connecting member 120 may be oriented parallel or substantially parallel to the longitudinal edge 405 of the base assembly 415.

FIG. 8 shows an embodiment of the sign assembly 800. This view shows both the highest extending members 525 and the extending members 115. The highest cross-connecting member 125 may support the sign 130. The sign 130 may be connected to the highest cross-connecting member 125 by connector(s) 810.

The connector(s) 810 may be part of the sign 130, may be formed with the highest cross-connecting member 125, or may be a separate component. The connector(s) 810 may be configured to allow the sign 130 to be both removed from and attached to the highest cross-connecting member 125. FIG. 8 shows the connectors 810 connecting the sign 130 to the highest cross-connecting member 125.

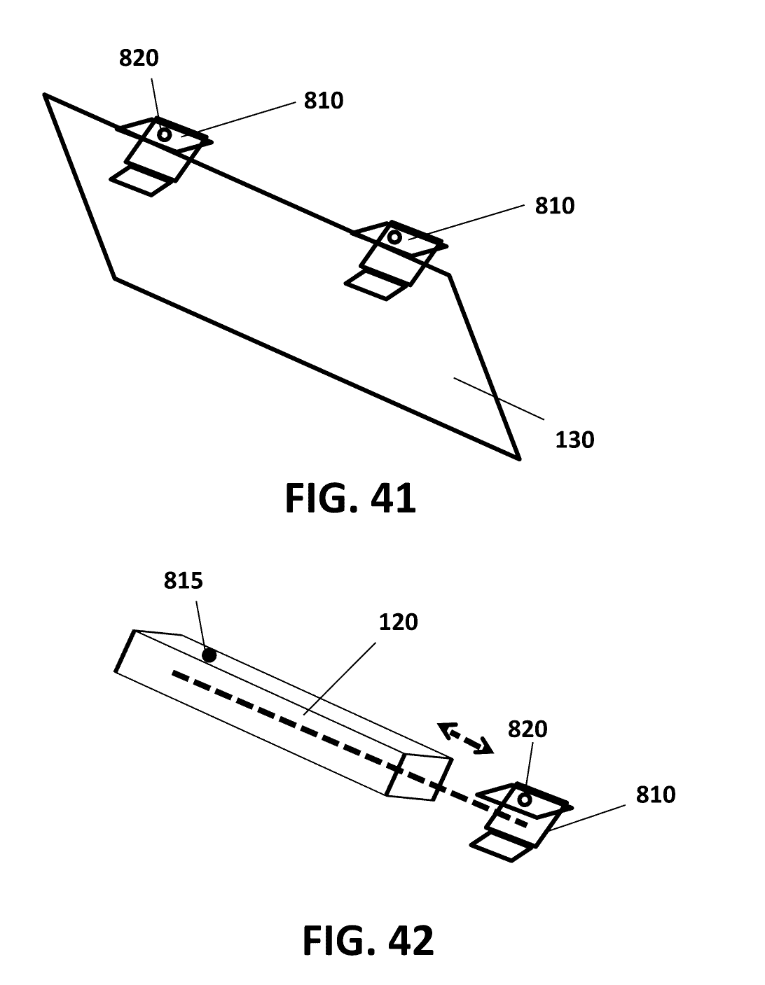

As shown in more detail in FIG. 41, the connector(s) 810 may be formed as a part of the sign 130. The connector(s) 810 may be made of a similar material as the sign, or any other metal, plastic, etc. The connector(s) 810 may be sized to fit around the highest cross-connecting member 125 as shown in FIG. 42. This sizing may allow the connector(s) 810 to slide onto the highest cross-connecting member 125. To lock and unlock the connector(s) 810 in place to allow removal of the sign 130, the highest cross-connecting member 125 may have a depressable member 815 that fits within a hole 820 that may be provided on a top surface of the connector 810. The depressable member 815 may be pressed by a user to facilitate removing the connector 810 and the sign 130 from the highest cross-connecting member 125. Additional embodiments for the connector(s) 810 are certainly possible, as all that is needed is a connection to hold the sign 130 into place. For example, the sign 130 may be connected via an adhesive, a Velcro means, a zip-tie type fastening means, a screw fastening means, or any combination thereof.

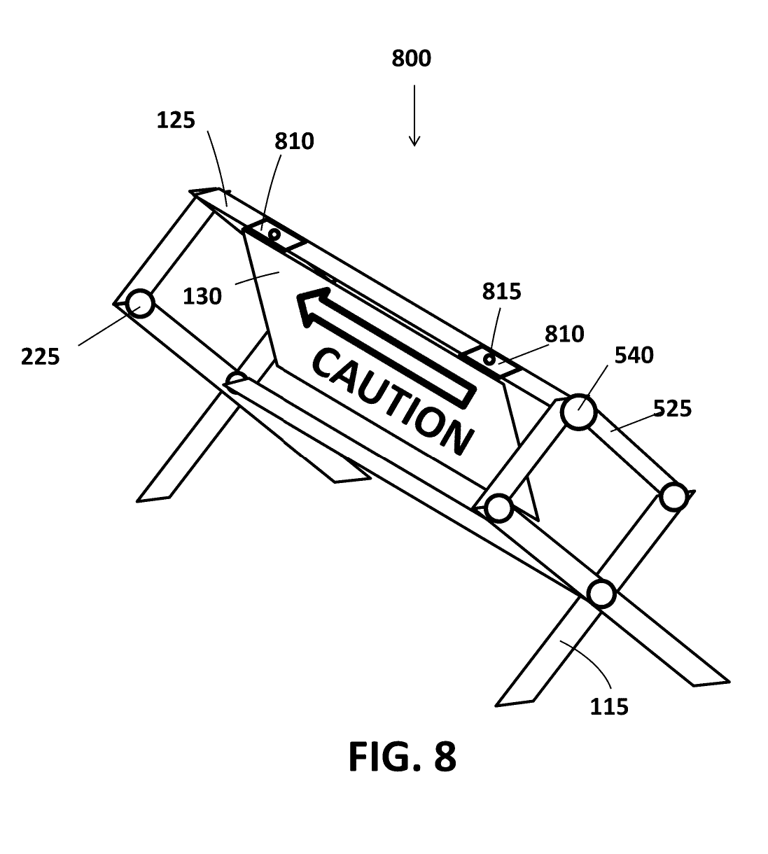

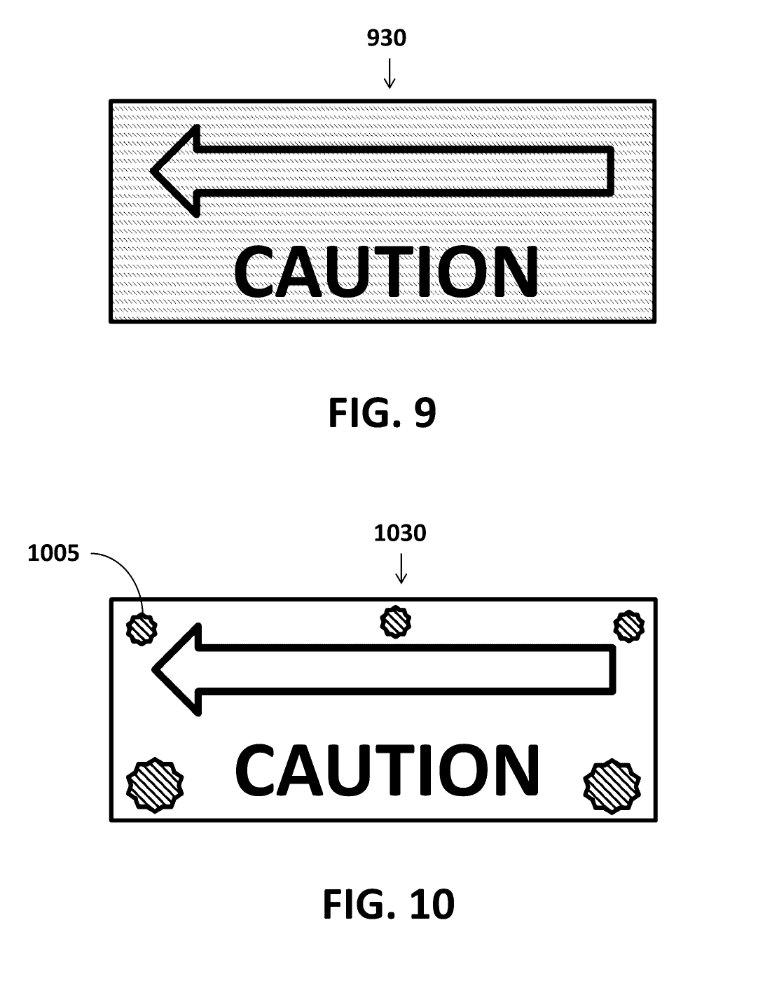

In the embodiment of the device shown in FIG. 9, the sign 130 has a reflective background surface 930. For example, the entire sign may be made of any material designed to reflect light, the sign may be made of any type of plastic or metal and may be coated with a reflective, or any combination thereof. It is also noted that the sign 130 of FIG. 9 or any embodiments may have the lettering, symbols, reflective material, and any combination thereof on one or both sides.

FIG. 10 shows another embodiment 1030 of the sign 130. In this embodiment, the sign 1030 includes reflective members 1005 that are affixed to the sign 1030. These reflective members 1005 may be attached to the sign via any attaching means, such as an adhesive element (e.g., glue), a separate securing element (e.g., zip-tie), or in a removable manner (e.g., Velcro), or any combination thereof. The reflective members 1005 could also be and/or include a coating that is painted on to the sign 1030.

FIG. 10 presents an example sign 1030 with five reflective members 1005, but there could be any number of reflective members 1005 on the sign 130. Additionally, these reflective members 1005 may be star-shaped as shown. The reflective members 1005 could also be any other shape or configuration. The reflective members 1005 can also be of varying sizes and any combination of shapes, sizes, and number of signs is certainly possible.

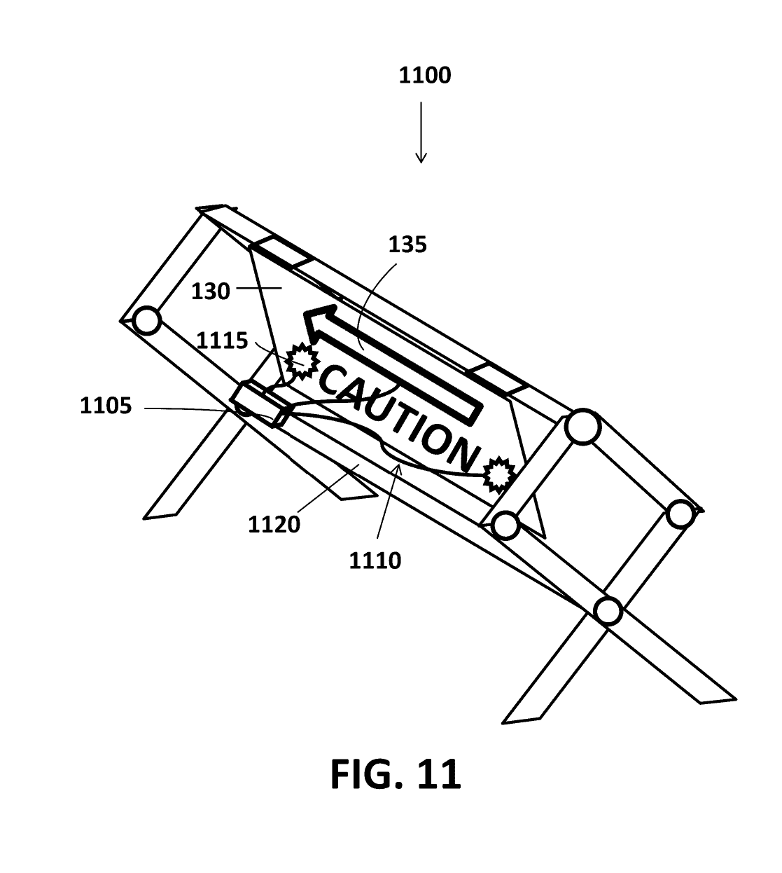

FIG. 11 illustrates another embodiment of the sign assembly 1100. In this embodiment, the sign 130 may be configured to light up. A battery pack 1105 may provide power to the arrow 135, the lettering 140, or the light emitting members 1115, or any combination thereof. The battery pack 1105 provides power to these items through wires 1110. The battery pack 1105 may comprise one battery or multiple batteries and may be housed in a common assembly or attached separately.

The battery pack 1105 may be attached to a battery supporting cross-connecting member 1120. The battery supporting cross-connecting member 1120 may be located directly under the highest cross-connecting member 125 when the device 100 is in the extending position as shown in FIG. 11. The battery 1105 may be attached to the battery supporting cross-connecting member 1120 by any known attaching means such as an adhesive (e.g., glue), a separate securing element (e.g., zip-tie), or in a removable manner (e.g., Velcro).

The battery pack 1105 may instead be provided anywhere else on the device 100 or as a separate element from the device. In this manner, the battery pack 1105 may be secured to an extending member 115, a cross-connecting member 120, the highest cross-connecting member 125, a base leg 110, the base assembly 105, etc.

The arrow 135, the lettering 140, or the light emitting members 1115, or any combination thereof can be configured to provide light of any color and/or brightness. These items may further be configured to blink, flash, or illuminate in any other manner in order to provide a visual warning, instruction, advertisement, or any combination thereof. The battery pack 1105 may be provided with a switch to turn the power on or off.

Other power sources instead of or in combination with the illustrated battery pack 1105 may be utilized. For example, an electrical outlet connection may be provided to provide power to the components of the sign 130. This outlet connection may connect with a power source of a car, such as the cigarette lighter. For another example, a solar power source could be used. Solar panels could be used to store energy, and then power could be distributed to the components of the sign 130 as appropriate.

The embodiment of the device 100 shown in FIG. 12 illustrates an example of the collapsed position. The base legs 110 may be removed from the openings 205 in the base assembly 105 as discussed above regarding FIGS. 37-39. Removal may allow the base legs 110 to be moved downwards and positioned in contact with the top side 215 of the base assembly 105. In this position, the base legs 110 may run parallel or substantially parallel with transverse edge 410 of the base assembly 105.

When the base legs 110 are removed from the openings 205 and folded downwards, this also may allow the extending members 115 to fold downwards. This movement changes the extending members 115 from the expanded position to the collapsed position. The extending members 115 also may fold downwards towards the top side 215 of the base assembly 105. In the collapsed position, the extending members 115 may be positioned against and in contact with either the top side 215 of the base assembly 105 or abutting the folded down based legs 110. In this position, the extending members 115 may be positioned to be parallel or substantially parallel with transverse edge 410 of the base assembly 105.

When the base legs 110 and the extending members 115 are moved downwards as described into the collapsed position, this also may cause the cross-connecting members 120 to move downwards. In the collapsed position, the cross-connecting members 120 also may abut the top side of the base assembly 105, but the cross-connecting members 120 may be oriented to be parallel or substantially parallel with the longitudinal edge 405.

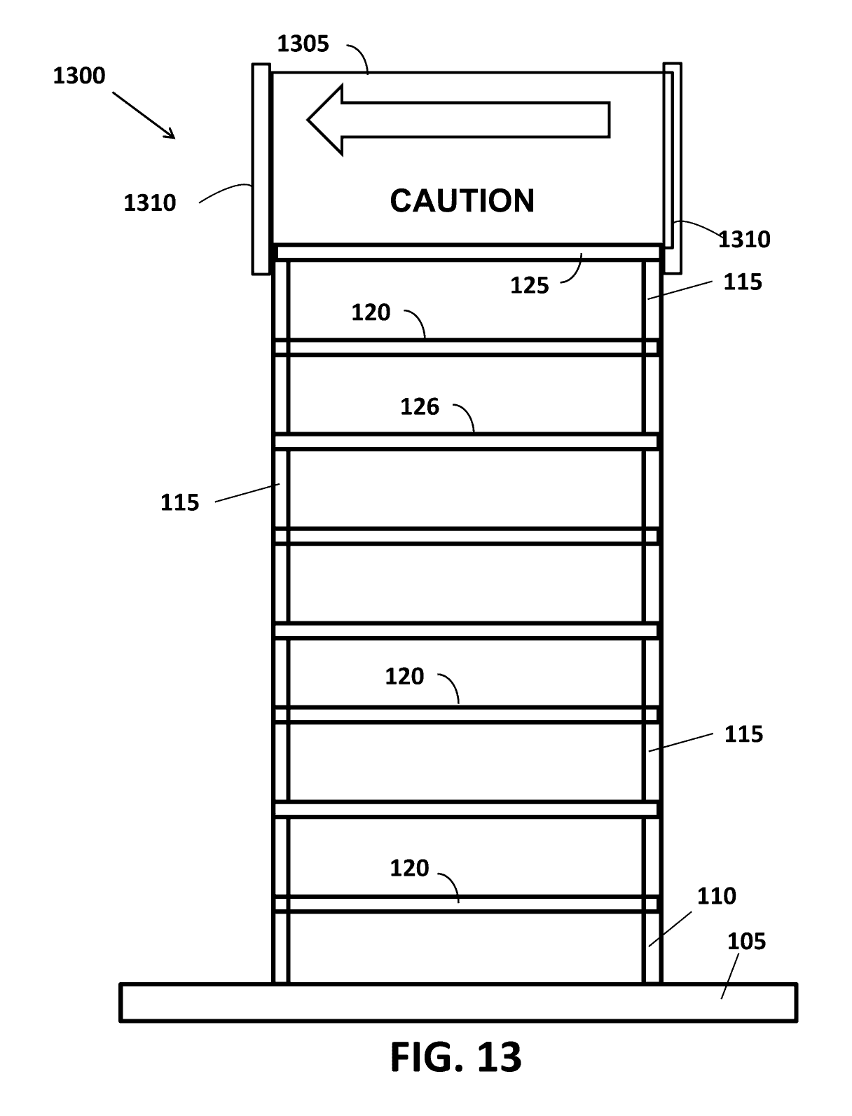

FIG. 13 illustrates another embodiment of the device 1300. The device 1300 has base legs 110, extending members 115, cross-connecting members 120, and a highest cross-connecting member 125 as discussed for the device 100. The base legs 110, extending members 115, and cross-connecting members 120 may form rectangular prisms 230 when in the extending position. The device 1300 has a similar construction as discussed above and so only new elements will be discussed regarding this embodiment. This embodiment of the device 1300 shows another sign 1305 configuration. It will be recognized that the sign 130 of the device 100 of the first embodiment may be the sign 1305 in the second embodiment of the device 1300, or a different sign 1305 may be utilized.

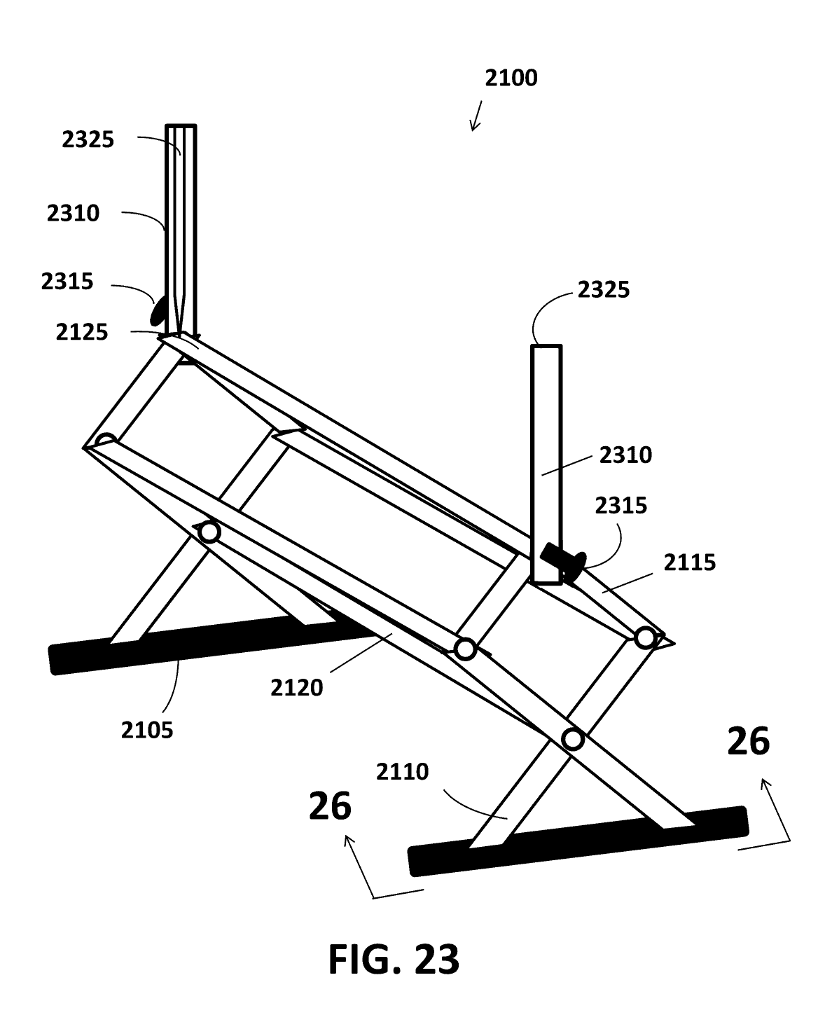

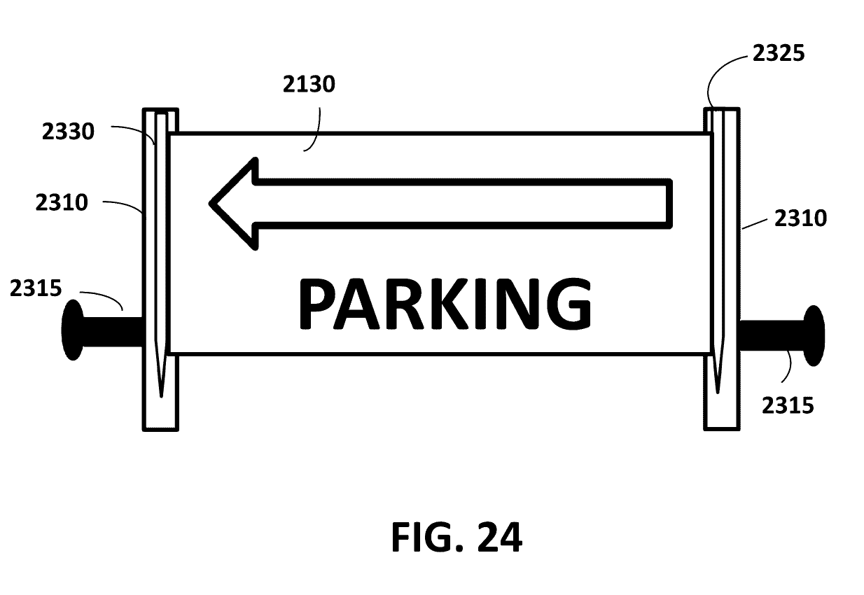

The sign 1305 of the device 1300 may extend upwards from the highest cross-connecting member 125. It may be that no portion of the sign 1305 extends below the highest cross-connecting member 125. The sign 1305 may not attach to the highest cross-connecting member 125 with the connector(s) 810. Instead, in this embodiment, two vertical sign supporting members 1310 may laterally support the sign 1305. The bottom side of sign 1305 may also abut and be supported by the highest cross-connecting member 125. More details of the sign 1305 connection with the vertical sign supporting members 1310 are provided below in the discussion of FIGS. 23 and 24.

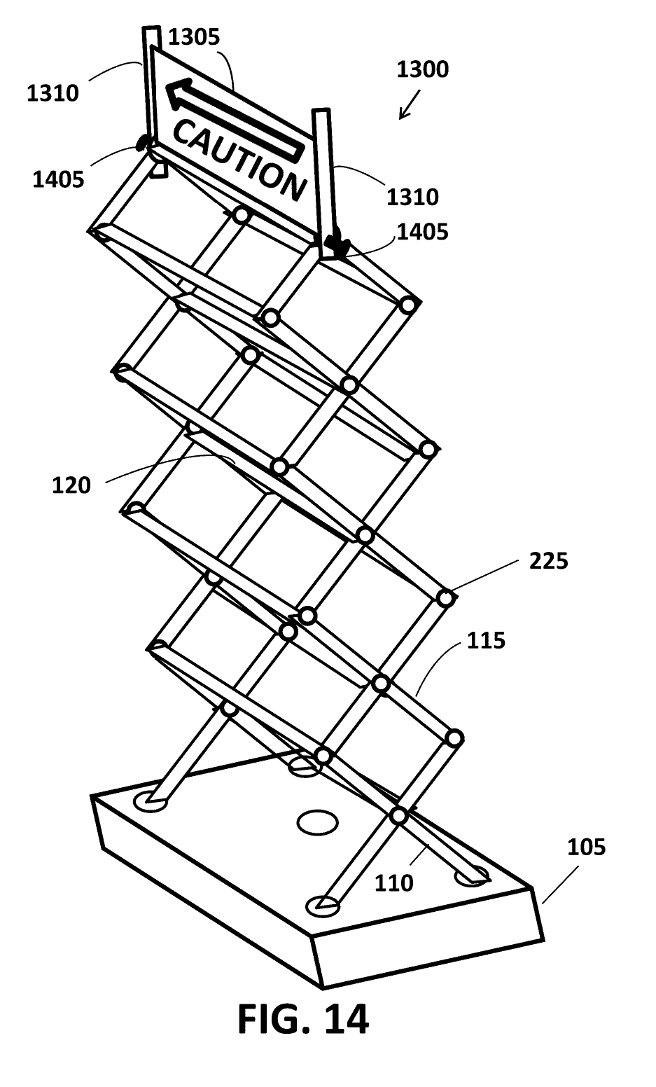

FIG. 14 shows a perspective view of the embodiment of the device 1300 shown in FIG. 13. FIG. 14 shows an embodiment of the device with a similar center structure as the embodiment of the device 100 shown in FIG.2, regarding the base assembly 105, base legs 110, extending members 115, cross-connecting member 120, and joints 225. This description will then focus on some of the differences between the device 100 shown in FIG. 2 and the embodiment of the device 1300 shown in FIG. 14.

The two vertical sign supporting members 1310 may extend upwards from the highest cross-connecting member 125. These vertical sign supporting members 1310 may be provided laterally outside of each end of the highest cross-connecting member 125. In other words, the vertical sign supporting members 1310 may be positioned at each end of the highest cross-connecting member 125. The vertical sign supporting members may be configured to extend below the highest cross-connecting member 125, but the sign 1305 may be configured not to slide below the highest cross-connecting member 125 in this embodiment.

FIG. 14 also illustrates the sign fastening members 1405. These will be described further below, but in general, the sign fastening members 1405 may be utilized to secure the sign 1305 between the vertical sign supporting members 1310. Examples of sign fastening members 1405 are fastening mechanisms such as screws, nuts, bolts, or any other operable fastener. The fastening members 1405 may also be positioned to secure the vertical sign supporting members 1310 to the device.

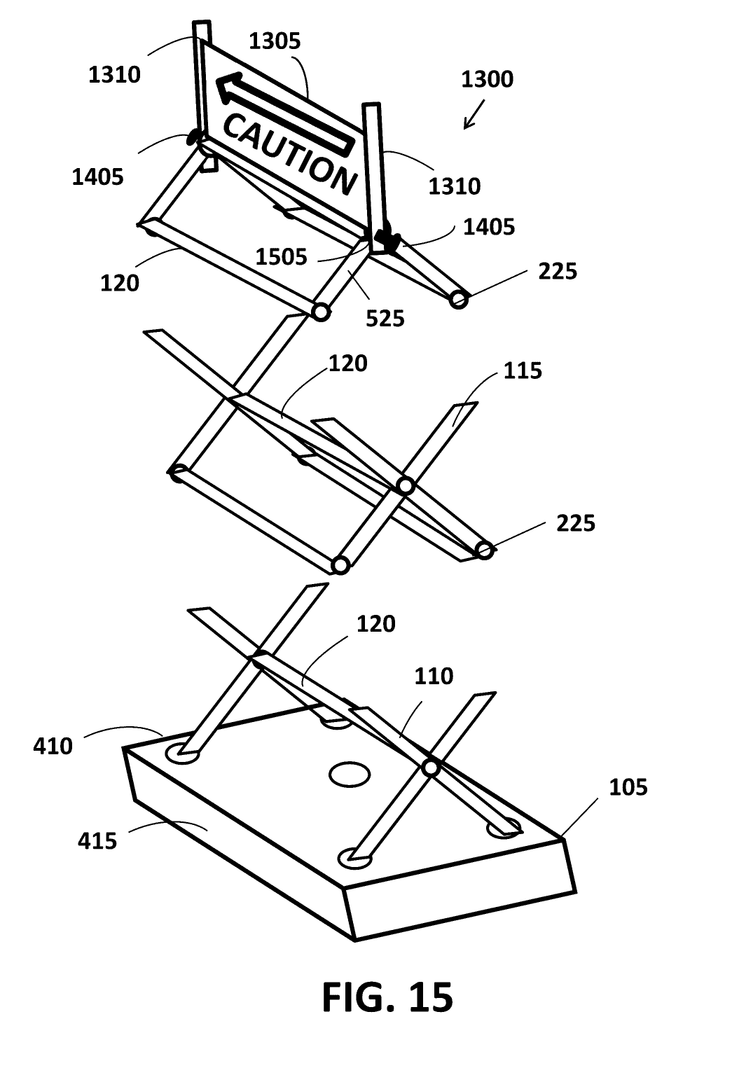

FIG. 15 illustrates an exploded perspective view of the device 1300. As in FIG. 5, only one of the central extending members 115 and cross-connecting members 120 is shown, but the device is not limited to only one central section. More sections with this configuration may be added to increase the overall height of the device. FIG. 15 shows that the connection in device 1300 between the base legs 110, extending members 115, and cross-connecting members 120 may be similar to the configuration of device 100.

As discussed above, the base legs 110 may have a top portion that connects to a bottom portion of an extending member. Joints 225 may be utilized to secure this, and the other, connections. The cross-connecting members 120 may connect the respective bottom portions, midpoints, and upper portions of extending members 115 that may be opposite to one another.

The highest extending members 525 may again be shorter in length than the other extending members 115. There may only be a joint 225 at the bottom portion and the top portion of the highest extending members 525. The top portion 535 of the highest extending members 525 may be connected to the highest cross-connecting member 125. This structure may provide support for the sign 130 and the vertical sign supporting members 1310. The highest joint 1505 may be larger than the other joints 225 if necessary to support the weight of the sign 130 and the vertical sign supporting members 1310. The highest joint 1505 may alternatively be sized the same as the other joints 225.

A sign assembly 1600 of the embodiment of device 1300 is illustrated in more detail in FIG. 16. The two vertical sign supporting members 1310 may extend below the highest cross-connecting member 125. The two vertical sign supporting members 1310 may connect to the extending members 115 and highest cross-connecting member 125 by the fastening members 1405. The fastening members 1405 may also secure and unsecure the sign 1305.

The lateral edges of sign 1305 may fit into grooves 1605. The grooves 1605 may be tapered at a lower portion, so that when the sign 1305 is slid downwards to contact the highest cross-connecting member 125, the sign 1305 has reached the bottom of the grooves 1605. When the sign 1305 has been slid downwards to reach this position, the fastening members 1405 can be laterally moved towards the sign 1305 to secure the sign in place. The fastening members 1405 can be laterally moved in the other direction to unsecure the sign 1305. This allows a user to remove the sign 1305 from the device 1300. Further details of the sign 1305, the two vertical sign supporting members 1310, the fastening members 1405, and the grooves 1605 are illustrated on FIGS. 23 and 24 and discussed in more detail below.

The two vertical supporting members 1310 may be removable from the device 1300. Alternatively, these two supporting members 1310 may be permanently affixed to the device 1300, for example, by an adhesive element (e.g., glue), a separate securing element (e.g., zip-tie), or in a removable manner (e.g., Velcro), by the fastening members 1405, or any combination thereof. The two vertical supporting members 1310 may also be configured to rotate around the highest joints 1505 or the fastening members 1405 so that the vertical supporting members 1310 can be positioned horizontally when the device 1300 is in the collapsed position. This folding may allow the device 1300 to be more compact in the collapsed position than if the vertical supporting members 1310 remain permanently vertical.

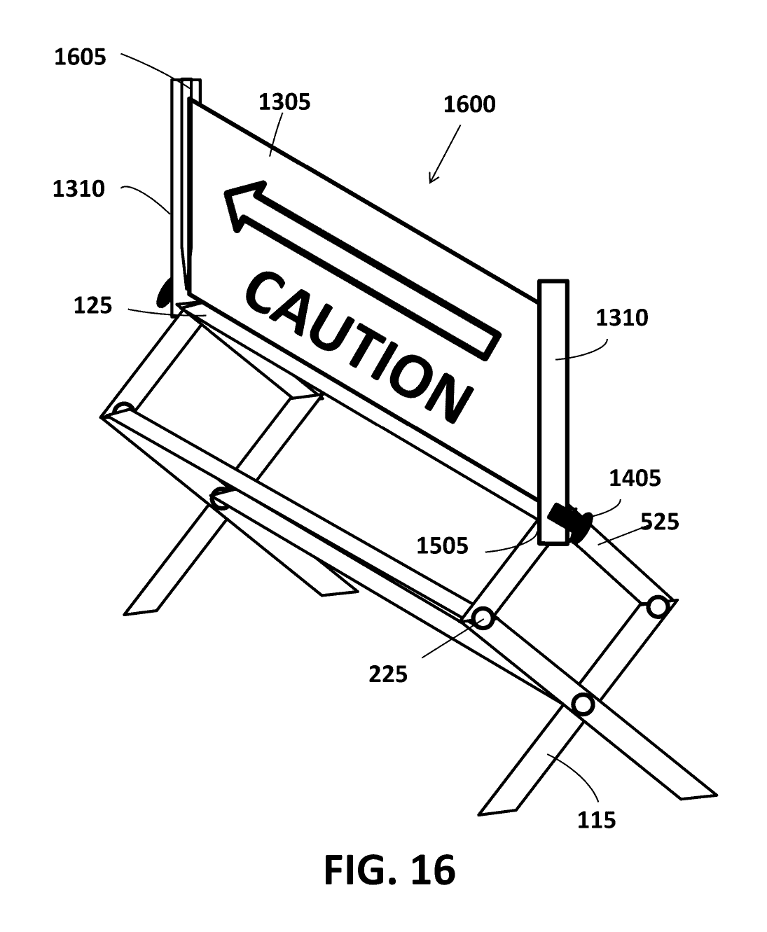

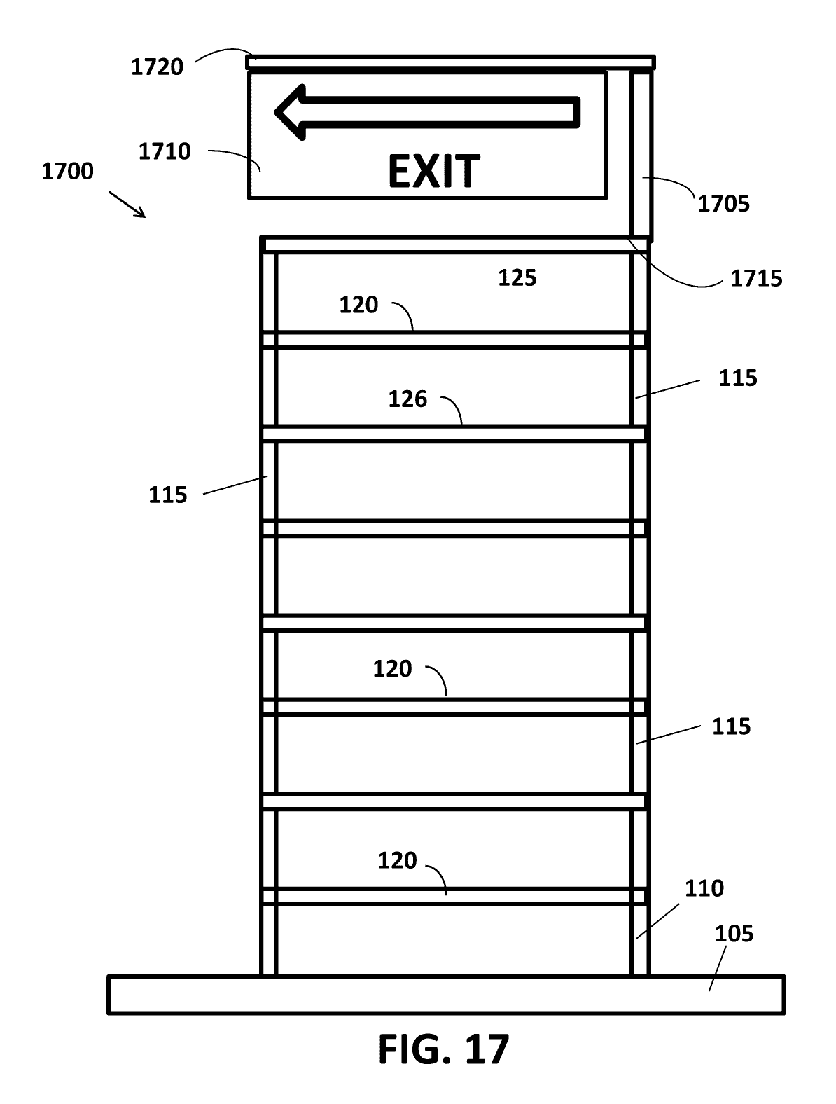

Another embodiment of the device 1700 is shown in FIG. 17. The device 1700 of this embodiment also has base legs 110, extending members 115, cross-connecting members 120, and a highest cross-connecting member 125 as discussed for the devices 100, 1300. The device 1700 may utilize an extending sign supporting member 1705 and supports the sign 1710 in a different manner than the embodiments of the device 100, 1300 discussed above.

The extending sign support member 1705 may project upwards from the highest cross-connecting member 125 when the extending members 115 are in the extended position. The connection between the extending sign support member 1705 and the highest cross-connecting member 125 can either be at one of the highest joints 1715 as shown in FIG. 17 or can be anywhere else on the highest cross-connecting member 125 or in another manner supported by the structure of the device 1700. The extending sign support member 1705 may allow the sign 1710 of this embodiment of the device 1700 to extend above the device 1700. A lateral sign support 1720 may connect the extending sign support member 1705 to the sign 1710.

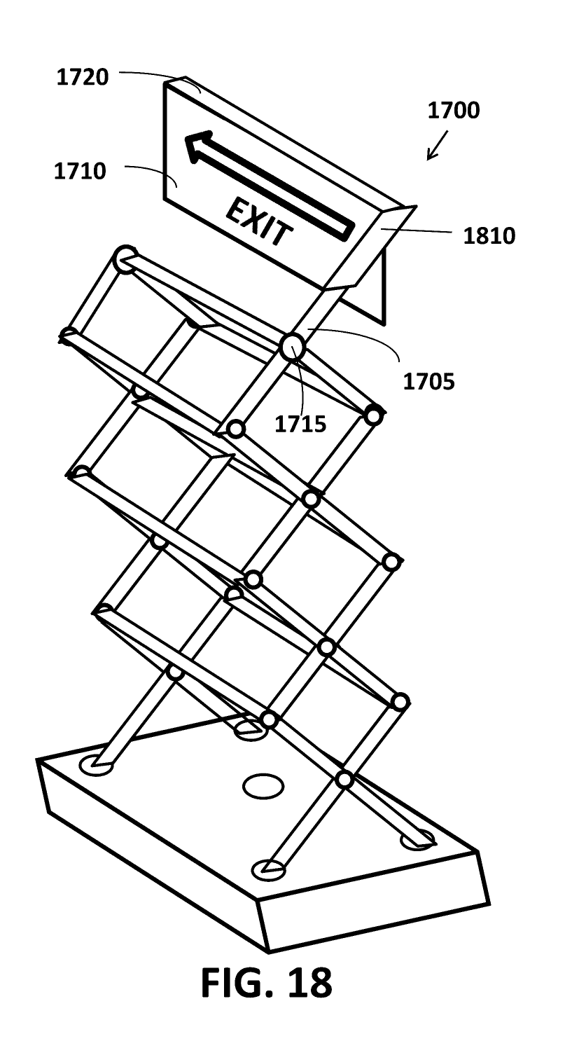

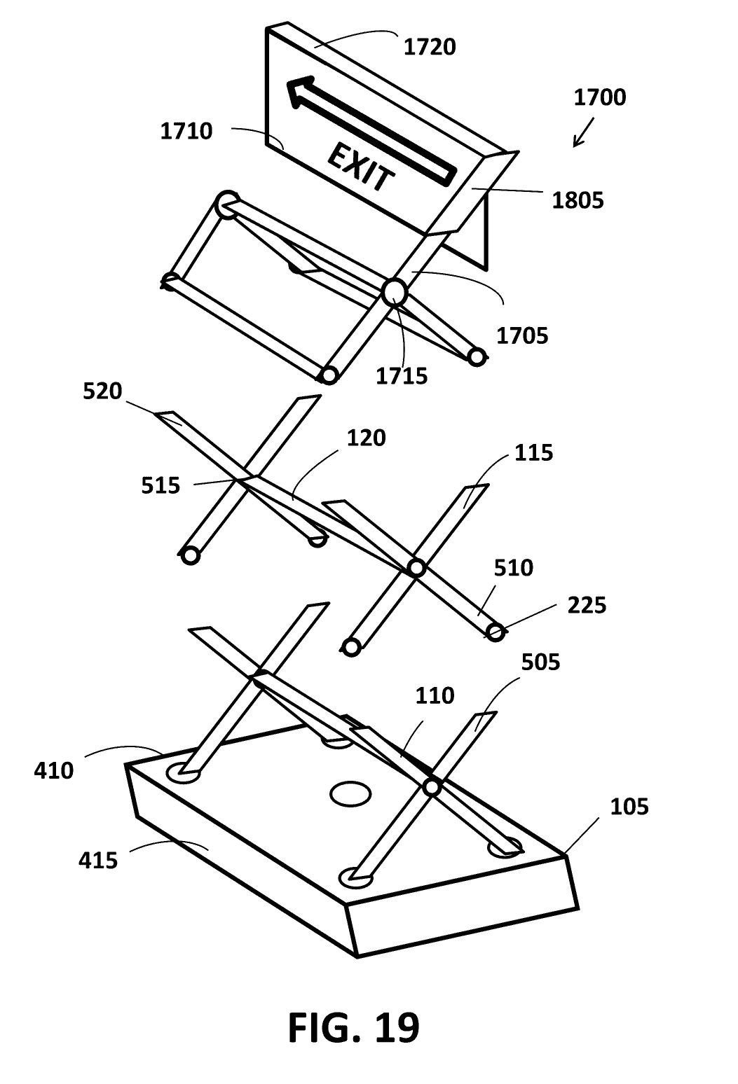

FIG. 18 shows a perspective view of the embodiment of the device 1700 shown in FIG. 17. The extending sign support member 1705 may project at an angle in a similar orientation as the extending members 115. The extending sign support member 1705 may be formed of two separate members or one uniform member. The extending sign support member 1705 may be connected to the highest cross-connecting member 125 at a highest joint 1715. The device 1700 may also include a connection sleeve 1810 to strengthen the connection between the extending sign support member 1705 and the lateral sign support 1720. The connection sleeve 1810 may also not be utilized in this embodiment of the device 1700. As shown in the exploded view of FIG. 19, the structure of the device 1700 may be configured in a similar manner as the other embodiments of the device 100, 1300 discussed above.

The sign assembly 2000 shows a different embodiment for this device 1700. An example of the sign assembly 2000 is shown in FIG. 20. However, the configuration of the sign 1710 may be any variation of the assembly 2000 illustrated. The sign assembly 2000 allows the sign 1710 to be readily visible. The extending sign support member 1705 may extend from a joint 225 or can connect with another extending member 115 at one of the highest joints 1715 and extend from that location. The sign 1710 may be removably or permanently affixed to lateral sign supporting member 1720 in any manner known to one of ordinary skill in the art. For example, the connection shown in FIGS. 41-42 may be utilized. Instead of providing the hole 820 and depressable member 815, the sign 1710 may be affixed to the lateral sign supporting member 1720 through any attaching means, such as an adhesive element (e.g., glue), a separate securing element (e.g., zip-tie), in a removable manner (e.g., Velcro), or any combination thereof.

FIG. 21 illustrates another distinct embodiment of the device 2100. The structure of the embodiment shown in FIG. 21 is different from the devices 100, 1300, 1700 discussed above. The base assembly of this embodiment of the device 2100 may have two separate base members 2105. The base members 2105 may be positioned perpendicular or substantially perpendicular with the cross-connecting members 120 as shown in FIG. 21. The configuration of the base members 2105 is discussed in more detail below regarding FIGS. 25 and 26.

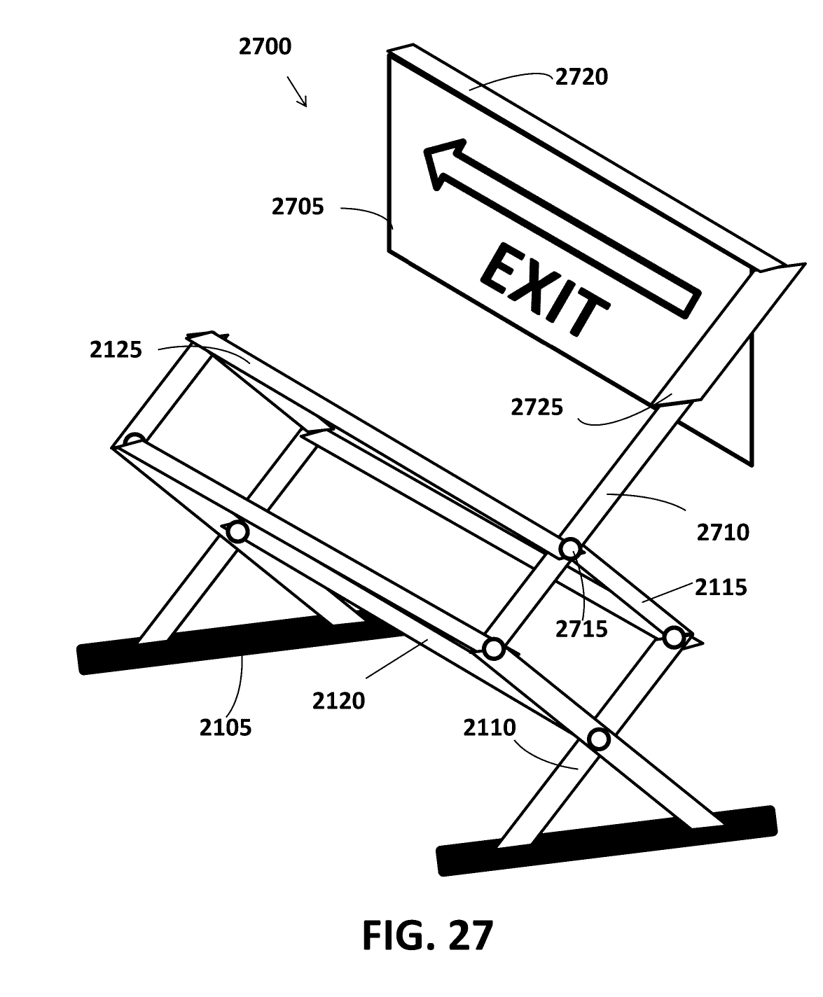

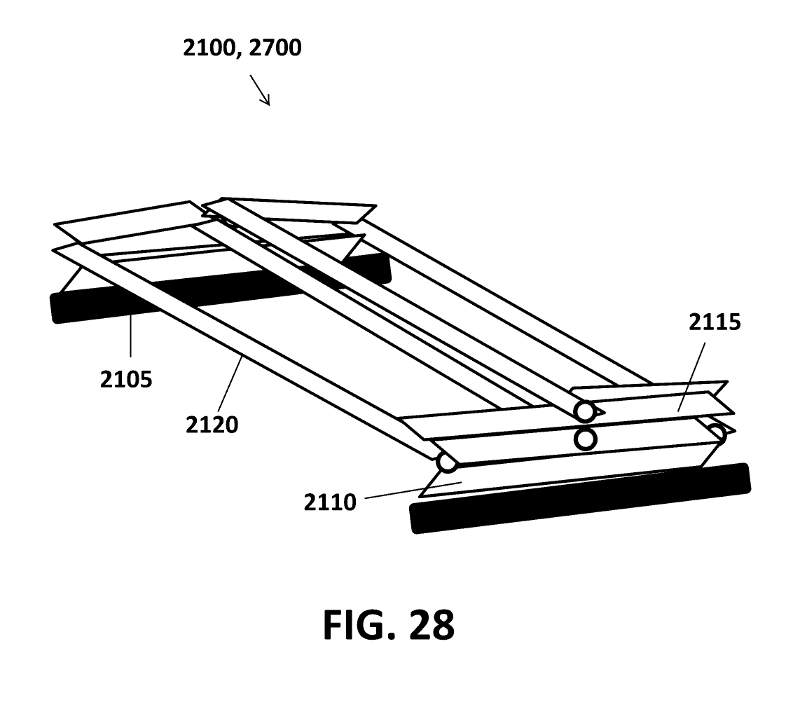

The device 2100 may include four base legs 2110, four extending members 2115, and four cross-connecting members 2120. The four extending members 2110 may be approximately half of the length of the base legs 2105. There again may be a highest cross-connecting member 2125. The highest member 2125 of the cross-connecting members 2120 may be the same structure as the cross-connecting members 2120, or may be formed of a stronger material or in a thicker manner, for example, to provide additional support of the sign 2130. The base legs 2110, extending members 2115, and cross-connecting members 2120 are shown in the extending position. The collapsed position is shown on FIG. 28 and is discussed further below.

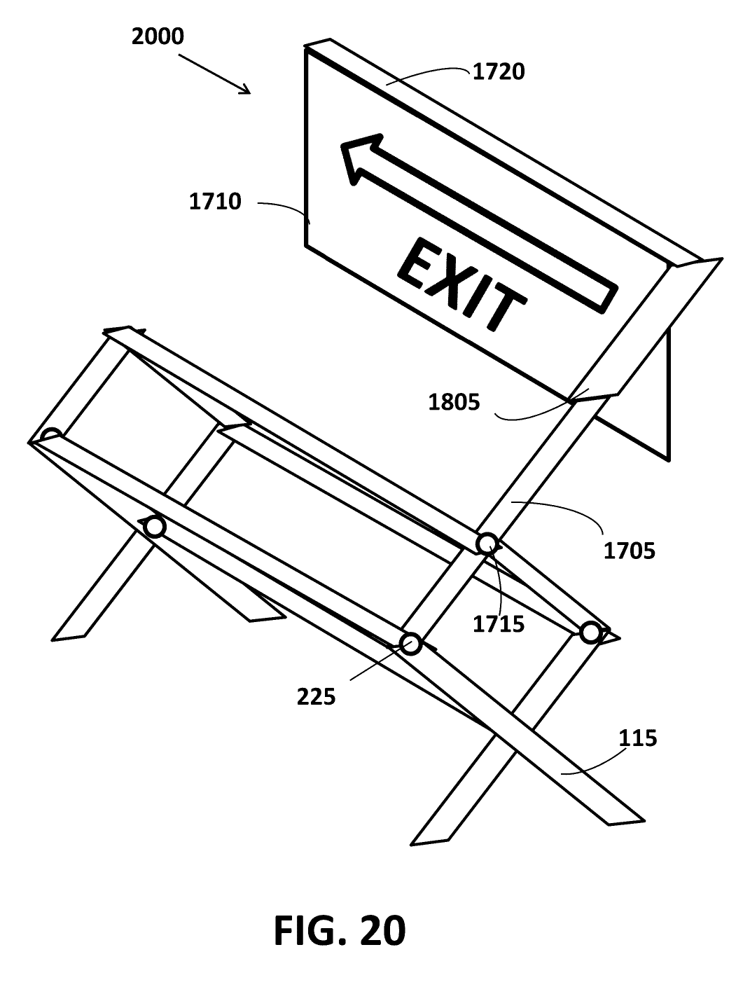

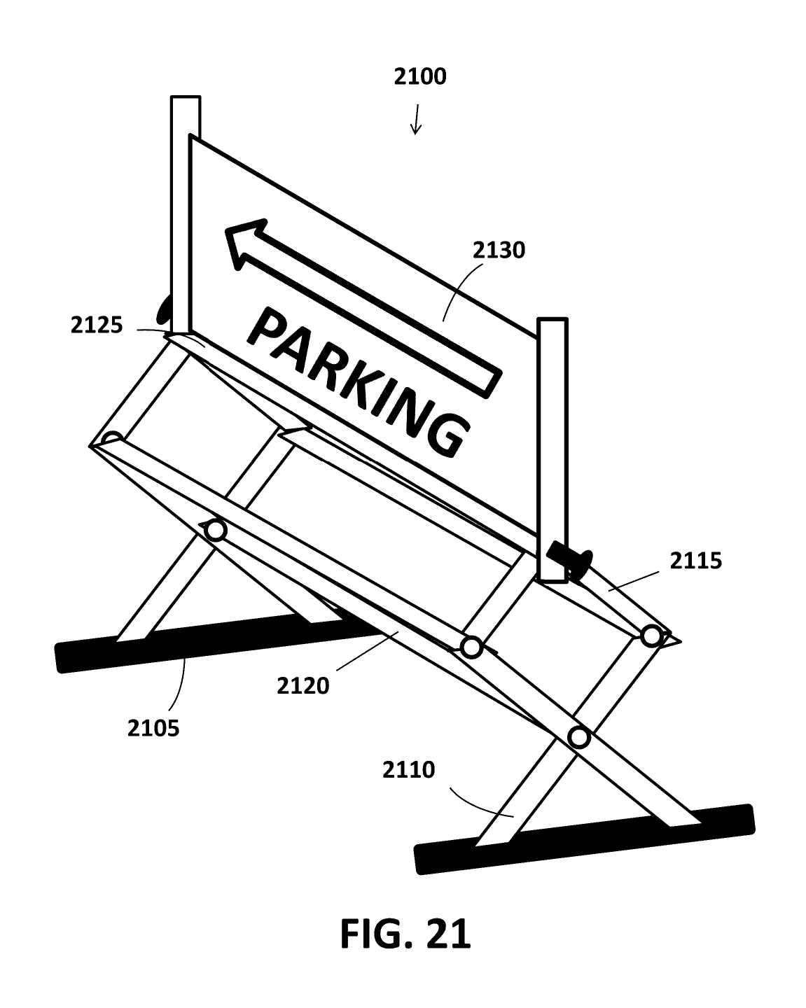

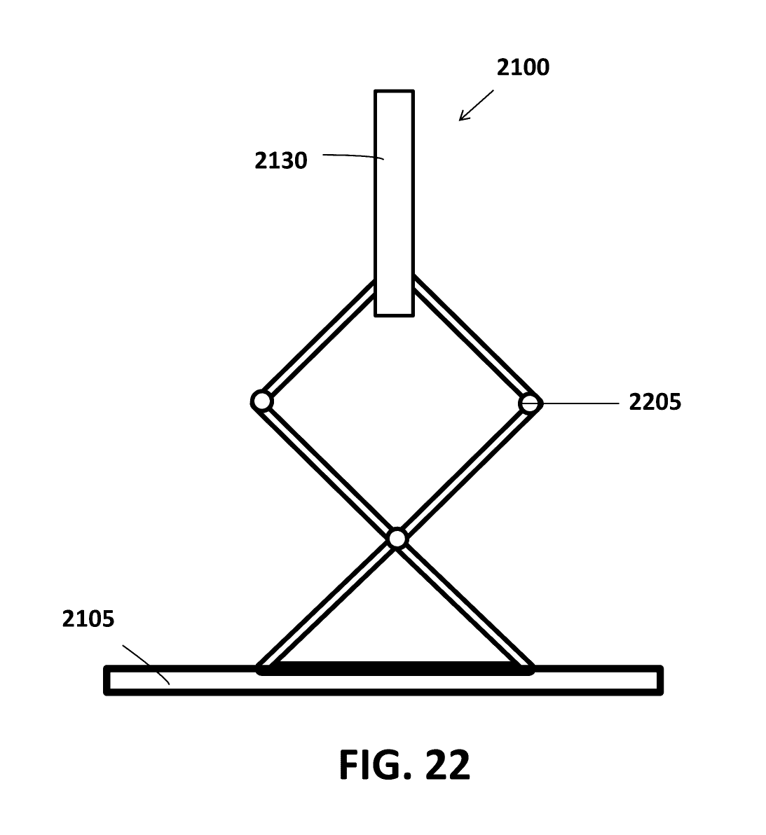

As seen from the side view in FIG. 22, in the extending position, this embodiment of the device 2100 forms a triangle at the base and a diamond-shape above the triangle. The sign 2130 is in the middle of the structure, which creates a more balanced device 2100. The side view also shows that this embodiment of the device 2100 has joints 2205. These joints 2205 may connect the various supporting structure members 2110, 2115, 2120 in the same manner as discussed for the other embodiments of the device 100, 1300, 1700, for example, as shown in FIG. 40.

FIG. 23 presents a perspective view of the device 2100, but with the sign 2130 removed. The sign 2130 may be configured to be inserted and removed from the device 2100 by the user. This may allow for more convenient storage and assembly. The sign 2130 may be supported on the outer edges by two vertical support members 2310. These two vertical support members 2310 may connect to the device in the manner discussed above regarding FIG. 16.

Fastening members 2315 may secure the sign 2130 in place from each opposing lateral side. The fastening members 2315 may move inwards towards the sign 2130 to secure the sign 2130 and away from the sign 2130 to unsecure the sign 2130 to allow the sign to be removed from the vertical support members 2310. The fastening members 2315 may, for example, screw and unscrew into and out of a hole in each of the vertical support members 2310 to facilitate this lateral movement.

The two vertical support members 2310 also may contain grooves 2325 to create a slot that provides more stability for the sign 2130 when the sign 2130 is inserted into the grooves 2325. The two grooves 2325 may taper at the bottom as the grooves 2325 approach the highest cross-connecting member 2125. FIG. 24 shows a view of the sign 2130 after insertion into the grooves 2325 of the vertical support members 2310.

FIGS. 25 and 26 show magnified views of a bottom portion of one of the base legs 2110 and one of the base members 2105 of the device 2100. The base legs 2110 may contain projecting portions 2505 that may allow the base legs to be secured in the base members 2105. The projection portions 2505 may be formed of a compressible material to allow the projection portion 2505 to compress for insertion into and removal from the base member 2105. The base members 2105 may contain openings 2605 which correspond to the projection portions 2505. The projection portions 2505 of the base legs 2110 may be insertable and removable from the openings 2605 of the base members 2105. The device 2100 may be placed in the extending position when the projection portions 2505 of the base legs 2110 are inserted into the openings 2605 of the base members 2105. The device 2100 moves to the collapsed position as seen in FIG. 28 when the projection portions 2505 of the base legs 2110 are removed from the openings 2605 of the base members 2105.

The base legs 2110 and openings 2605 could alternatively be configured in a similar manner as the base legs 100 and openings 205 discussed for another embodiment of the device 100, as depicted in FIGS. 37-39 and discussed in detail above.

FIG. 27 shows a perspective view of another embodiment of the device 2700 that is similar to the device 2100 in structure, but has the sign assembly 2000 illustrated in FIG. 20. The configuration of the sign 2705 may be any variation as discussed above. The extending sign support member 2710 may project out from and above the device 2700 to allow the sign 2705 to be positioned above the device 2700. The extending sign support member 2710 can connect with another extending member 2115 at one of the highest joints 2715 and extend from that location. The sign 2705 may be removably or permanently affixed to lateral sign supporting member 2720 in any manner known to one of ordinary skill in the art.

FIG. 28 shows the collapsed position for the embodiments of the devices 2100, 2700 that are illustrated on FIGS. 21 and 27. For the embodiment of the device 2700, the sign 2705 may have been previously removed by a user as illustrated in FIG. 28. When the projecting portions 2505 of the base legs 2110 are removed from the openings 2605 of the base members 2105, the base legs 2110, extending members 2115, and cross-connecting members 2120 may be folded downwards into the collapsed position. The base legs 2110 and the extending members 2115 may become positioned parallel or substantially parallel with the base members 2105. The cross-connecting members 2120 may be perpendicular or substantially perpendicular to the base members 2105.

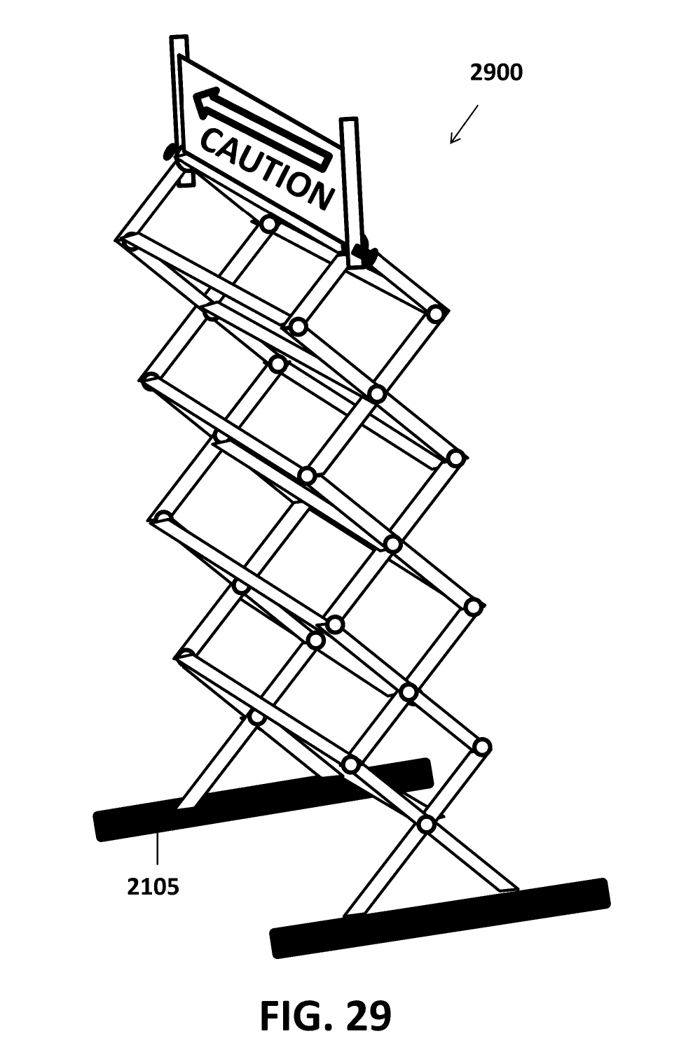

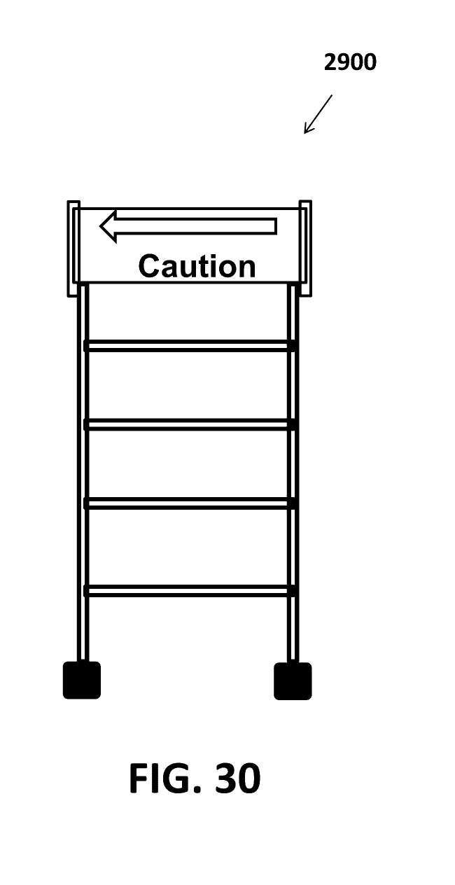

FIG. 29 shows a perspective view of an embodiment of the device 2900 where the base assembly consists of the two base members 2105. This base assembly may be combined with the upper structure of the embodiments of the device 100, 1300, 1700 illustrated in FIGS. 1, 13, and 17. FIG. 30 shows an elevation view of this embodiment of the device 2900.

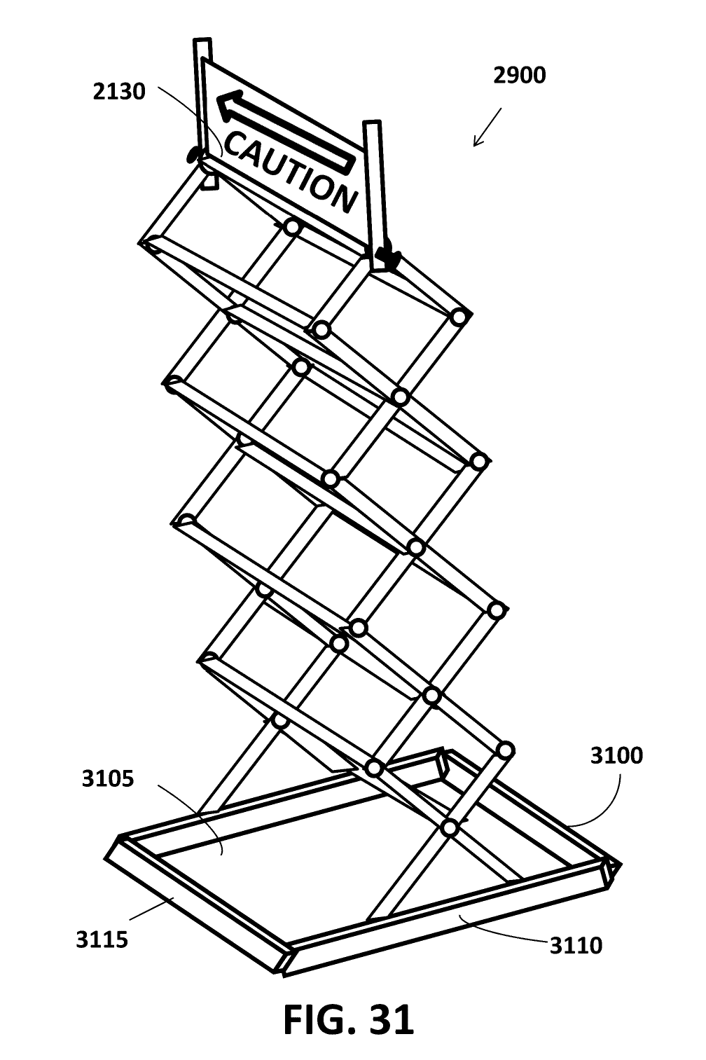

FIGS. 31-33 illustrate another base assembly 3100 configuration. The structure of the device 2900 or any of the other embodiments or configurations of the device 100, 1300, 1700, 2100, 2700 may be combined with base assembly 3100. The base assembly 3100 may be a rectangle-shape, and may have a hollow center area 3105. The base assembly may have two longitudinal sides 3110. The two longitudinal sides 3110 may connect with the base legs 2110. There also may be two lateral sides 3115 that may connect the two longitudinal sides 3110 to complete the rectangle shape.

This base assembly 3100 configuration may provide both longitudinal and lateral base support to, for example, provide the sign 2130 increased stability. The lateral sides 3115 that may connect the two longitudinal sides 3110 to complete the rectangle shape may be parallel to the cross-connecting members 120.

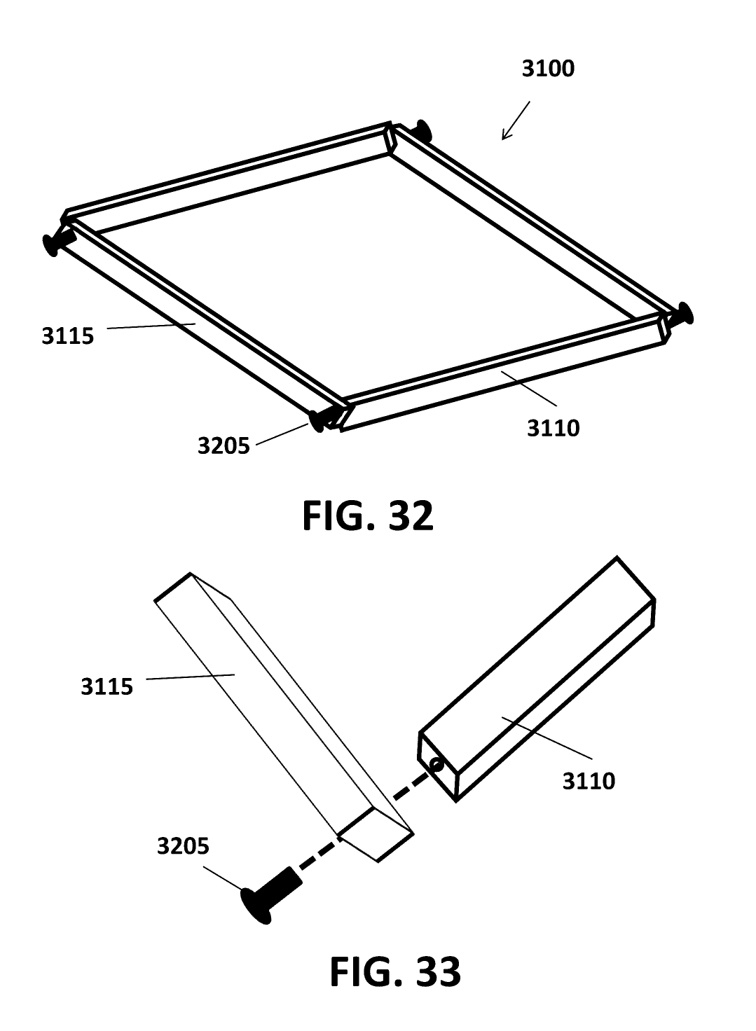

Base fastening members 3205 may be utilized to secure the longitudinal base members 3110 to the lateral base members 3115. FIG. 32 shows the base assembly 3100 in the secured position. The lateral base members 3115 may contain a hole for the base fastening members 3205 to screw into or move through to reach the longitudinal base members 3110. The base fastening members 3205 may screw or otherwise lock into the longitudinal base members 3115 to form the base assembly 3100. In an alternative embodiment, the base assembly 3100 could be extruded or formed in any other manner as a uniform component.

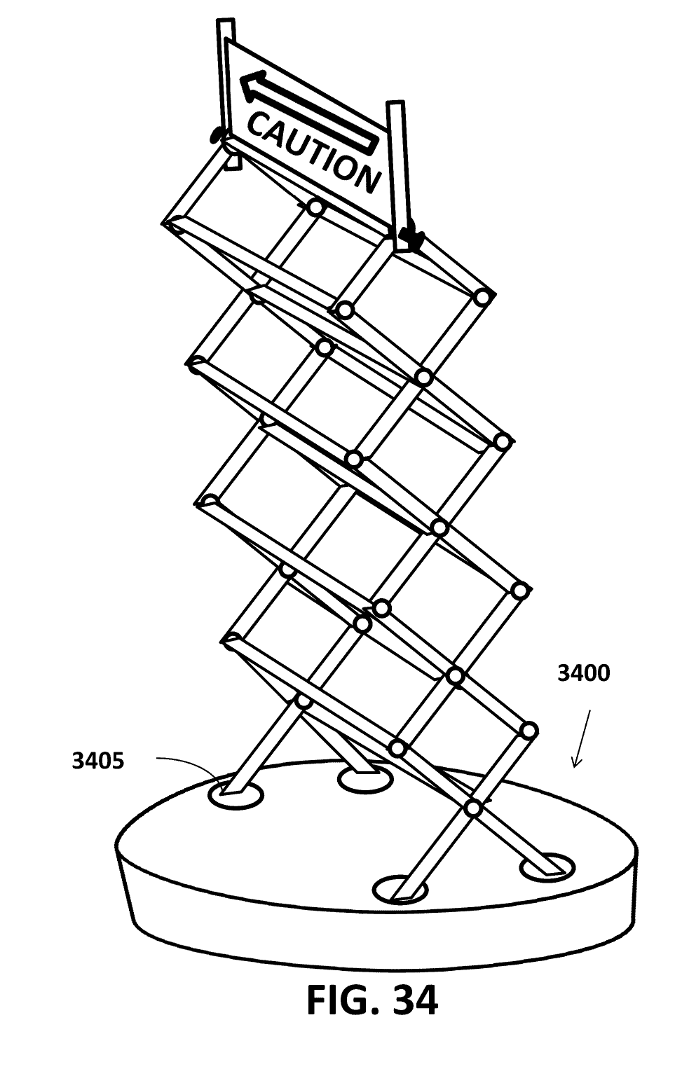

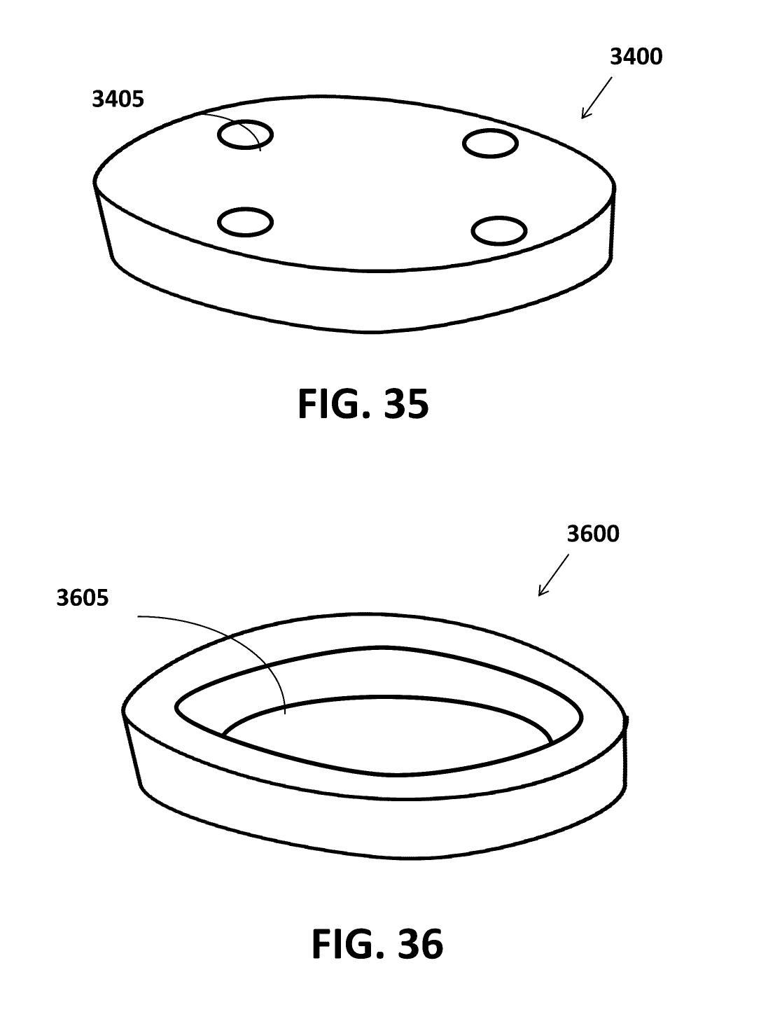

Finally, FIGS. 34-36 show base assemblies 3400 and 3600 that can be utilized as the base assembly for any of the embodiments of the device 100, 1300, 1700, 2100, 2700 discussed above. FIGS. 34 and 35 depict base assembly 3400. Base assembly 3400 is a circular or oval-shaped base member. The base assembly 3400 has openings 3405 for the base legs 110 of the device 100. Base assembly 3600 is another possibility, where the center 3605 of the base assembly 3600 is hollow.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures that highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A device comprising:
at least one base comprising at least one top side and at least one bottom side, the at least one top side comprising at least one opening;
at least one base leg corresponding to the at least one opening, wherein the at least one base leg comprises at least one bottom portion configured to be inserted into the at least one opening of the at least one base;
at least one extending member attached to the at least one base leg, the at least one extending member projecting upwards when in an extending position;
at least one cross-connecting member oriented in a lateral direction and attached to at least one of the at least one base leg and the at least one extending member, and
at least one sign configured to attach to the at least one cross-connecting member.

2. The device according to claim 1, wherein the at least one extending member is configured to project upwards at an angle.

3. The device according to claim 1, further comprising
at least one top cross-connecting member, the at least one top cross-connecting member positioned vertically higher than the at least one cross-connecting member when the at least one extending member is in the extending position.

4. The device according to claim 1, wherein the at least one base further comprises at least one plug configured to allow the at least one base to be filled.

5. The device according to claim 1, wherein
the at least one extending member includes a lower end, a midpoint, and an upper end, and
at least one cross-connecting member is attached at the lower end, the midpoint, and/or the upper end of the at least one extending member.

6. The device according to claim 1, further comprising at least one power source configured to provide power to at least one light source, wherein
the at least one light source is connected to the at least one sign.

7. The device according to claim 1, further comprising at least one joint configured to connect the at least one extending member and the at least one cross-connecting member.

8. The device according to claim 7, wherein at least one joint of the at least one joints is disposed to connect the at least one extending member, the at least one cross-connecting member, and the at least one base leg.

9. The device according to claim 1, wherein the at least one base leg is removable from the at least one opening in the at least one base.

10. The device according to claim 9, wherein the at least one base assembly further comprises at least one locking mechanism that is configured to secure and unsecure the at least one base leg.

11. The device according to claim 10, wherein the at least one base leg is configured to fold downwards when removed from the at least one opening in the at least one base.

12. The device according to claim 11, wherein the at least one extending member is configured to fold downwards when the at least one base leg is removed from the at least one opening and folded downwards towards the at least one base.

13. The device according to claim 12, wherein the at least one extending member is in a folded position when the extending member is fully folded to longer project upwards, and
the at least one extending member in the folded position is parallel to at least one edge of the at least one top side of the at least one base.

14. A device comprising:
at least one base comprising at least one top side and at least one bottom side, the at least one top side comprising at least one opening;
at least one base leg corresponding to the at least one opening, wherein the at least one base leg comprises at least one bottom portion configured to be inserted into the at least one opening of the at least one base;
at least one extending member attached to the at least one base leg, the at least one extending member projecting upwards when in an extending position;
at least one cross-connecting member oriented in a lateral direction and attached to at least one of the at least one base leg and the at least one extending member,
at least one sign supporting member connected to the at least one extending member, and
at least one sign configured to be supported by the at least one sign supporting member.

15. The device according to claim 14, wherein the at least one sign supporting member projects vertically upwards and is configured to laterally support the at least one sign.

16. The device according to claim 14, wherein the at least one sign supporting member projects upwards such that the at least one sign is positioned vertically higher than the highest of the at least one cross-connecting member(s) when the at least one extending member is in the extending position.

17. The device according to claim 14, further comprising at least one fastening element configured to secure at least one of the at least one sign and the at least one sign supporting member.

18. The device according to claim 17, wherein the at least one sign supporting member comprises a vertical slit, such that the at least one sign supporting member is configured to allow the at least one sign to slidably move upwards and downwards within the vertical slit.

19. The device according to claim 14, wherein when the at least one extending member is in the extending position, the at least one sign supporting member is configured to extend the at least one sign so that the at least one sign does not contact the highest of the at least one cross-connecting members.

20. The device according to claim 19, wherein the at least one sign supporting member is formed integrally with at least one of the at least one extending members.
